(19) United States
(12) Patent Application Publication
(10) Pub. No.: US 2015/0213552 A1
(43) Pub. Date: Jul. 30, 2015

(54) PRICING USER-DEFINED FINANCIAL INSTRUMENTS

(71) Applicant: VOLMASTER B.V., Amsterdam (NL)

(72) Inventor: Stefano SILVANO, Amsterdam (NL)

(21) Appl. No.: 14/605,130

(22) Filed: Jan. 26, 2015

(30) Foreign Application Priority Data
Jan. 24, 2014 (NL) 2012132

(51) Int. Cl. G06Q 40/04; G06F 9/44

(52) U.S. Cl. CPC G06Q 40/04; G06F 8/315; G06F 9/4428

(57) ABSTRACT

Systems and methods for the purpose of pricing, valuing and managing arbitrarily defined financial instrument or a contingent claim. Computer interface to allow a user to provide definitions of an instrument and the input of computer code expressed in a syntax that is compatible with a high-level object-oriented programming language. Methods are provided to create user interface at pricing time that is consistent with instrument definitions and provides validation of specific input values. Methods are provided to generate derived source code that combines instructions generated by program with the user-defined code; compile such derived source code into an executable pricing module; interface such binary code with user inputs and market data and price such instrument on any financial model that can be implemented by mean of a Monte Carlo simulation. Finally, the value of such instrument and its sensitivities on the selected financial model are reported.

### FIELD OF THE INVENTION

The invention relates to pricing user-defined financial instruments, and, in particular, though not exclusively, to a system and a software-implemented method for enabling pricing of an arbitrary user-defined financial instrument and computer program product using such method.

### BACKGROUND OF THE INVENTION

In recent years financial markets have exhibited a high degree of product innovation and an increasing pace of sophistication. Software tools supporting trading and risk management activities are normally based on pre-defined libraries that support only a limited number of financial instruments. A financial instrument may be regarded as a tradable asset of any kind; either cash, evidence of an ownership interest in an entity, or a contractual right to receive or deliver cash or another financial instrument. A special type of financial instrument is a derivative instrument, which derives its value from the value and characteristics of an underlying asset, index, or interest rate. Upgrading and expanding such tools, in order to cope with product innovation, is a lengthy and costly process, often requiring a team of high profile professionals for encoding each specific instrument into the system.

For example, WO2009/073783 describes method and system for computing financial values using a software platform that uses a declarative programming technique. In this scheme, a programmer may use the software to write and execute a program that can compute the price of a financial instrument such as a put of a call option. Although the proposed declarative programming language allows defining and pricing of a financial instrument, implementation of financial instruments using such specialized declarative languages are subject to a number of limitations. For example, the declarative programming language does not allow intuitive programming for more complex financial products by users that are not professional programmers. Further it requires a programmer to learn and master a specific declarative language, which is bounded, in terms of capabilities, by the number and quality of the primitives implemented in such specialized declarative language.

Prior art software tools for pricing arbitrary financial instruments are less suitable for fast development and release of new financial instruments by users who do not have professional software programming skills. Hence, there is a need in the art for improved methods and systems that enables pricing of arbitrary user-defined financial instruments.

### SUMMARY OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java(™), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention, In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is an objective of the invention to reduce or eliminate at least one of the drawbacks known in the prior art. In an aspect the invention may relate to a computer-implemented method for enabling pricing of a user-defined financial instrument, said method comprising a microprocessor in a computer executing computer readable program code of a main application, said program code being associated with an object-oriented programming language, preferably VB.net, C#.net or an equivalent thereof, that comprises one or more compiler classes.

In an embodiment, said program code may be configured for: providing a first user interface for receiving instrument definitions and user-code defining the contingent cashflows of at least part of a user-defined financial instrument as a function of at least part of said instrument definitions; receiving said user-code and at least part of said instrument definitions from a user interacting with said first user interface, said instrument definitions comprising at least an instrument name and one or more instrument objects and said user code comprising semantic expressions in accordance with the syntax of said object-oriented programming language; using said instrument definitions and said user code for programmatically generating a code wrapper in accordance with the syntax of said programming language, said code wrapper comprising semantic expressions configured for orderly passing of at least part of said instrument objects to corresponding instrument parameters in said user code and orderly returning output objects representing contingent cashflows values; combining said user code and said code wrapper into the source code of a pricing module; and, compiling said source code, preferably at runtime, into an executable pricing module by invoking said one or more compiler classes of said object-oriented language.

Hence, when the financial software application is executed, a user may interact with a graphical user interface for defining an arbitrarily user-defined financial instrument in an object-oriented programming language. The user code is subsequently automatically embedded in a programmatically-generated code wrapper (forming at least a header and a footer) that ensures correct transfer of parameter values to the user-defined code and return of a calculated result (contingent cashflows) of the financial instrument. As the financial software application is written in an object-oriented programming language that comprises compiler classes, the financial software application may, at runtime, compile the thus generated source code by invoking the compiler classes.

The method provides an effective way to provide flexibility and expandability to a financial software application, including trading and risk management tools, by incorporating a framework comprising a pricing system that allows end-users to write some software code and execute it directly in the pricing system. By writing software code directly inside the pricing system, a number of significant advantages may be achieved. The method does not require the need for external development tools and there is no need for software integration between the pricing system and the external code. Moreover, there is no risk of inconsistencies in the integration of a new product, as a coherent framework guarantees consistency of results.

The method provides the possibility of directly expanding a pricing system quickly and effectively with one or more arbitrarily user-defined financial instruments. The methods provides the financial software application with a competitive advantage for end users, as far as the capacity of offering new products and the speed to market of such products is concerned. Furthermore, when a pricing system embeds directly these product-extension capabilities, the formal process of validating and ‘releasing’ a new product for an organization can be organized and controlled effectively within the pricing system itself. For example, by attaching different end users of an organization to different roles and permissions and forcing an orderly process of creation, testing, validation and release.

In an embodiment, said instrument objects may comprise one or more date objects that refer to one or more dates within a period for which the price of said user-defined financial instrument is evaluated. In an embodiment, said code wrapper may comprise a first well-formed string of expressions and said user-code may comprise a second well-formed string of expressions and, wherein combining said user code and said code wrapper may further comprise: forming said derived source code by combining said first string with said second string of characters according to the syntax of said object-oriented programming language.

In an embodiment, said code wrapper may be further configured for defining the one or more variables in said user-code consistently with the instrument definitions; , one or more output objects wherein said user-code is configured to populate said one or more output objects at runtime.

The invention allows the creation of a programmatically-generated code wrapper for orderly passing of the objects values defining an instrument to the user-code, defining the variable names consistently (in terms of name and type) with the instrument definitions and/or populating each variable with the correct object value passed at runtime. This way, the code wrapper may comprise expressions that allows a coherent mechanism of passing object variables to the user code and provides consistency between the instrument definitions, the building of programmatically-modified source-code, the population of actual values at pricing time into the object variables and the parsing of such values into the compiled user-code.

In an embodiment, said user code may further comprise one or more validation rules comprising a logical condition associated with at least one of said instrument variables in said user-code and wherein said one or more validation rules may comprise semantic expressions that are in accordance with the syntax of said object-oriented programming language.

In an embodiment, said method may further comprise using said instrument definitions and said one or more validation rules for programmatically generating source code for a validation module, said validation module comprising semantic expressions configured for orderly passing of at least part of said instrument objects to corresponding instrument parameters in said validation subroutine; and, for generating error conditions on the basis of one or more logical conditions in said one or more validation rules.

In an embodiment, said method may further comprise compiling said source code of said validation module, preferably at runtime, into a executable validation module by invoking said one or more compiler classes of said object-oriented language.

In an embodiment, said method may further comprise: linking said executable pricing module and, optionally said executable validation module, to the main application at runtime. Hence, one or more executable pricing modules associated with user-defined financial instruments may be created and added to the main application in runtime.

In an embodiment, said method may further comprise: selecting a pricing model for describing the evolution over time of the price and possibly the volatility of one or more assets on the basis of one or more stochastic processes, the value of said user-defined financial instrument being derived from said evolution over time of one or more assets.

In an embodiment, said method may further comprise: using said selected pricing model for generating one or more Monte Carlo paths on the basis of current market data of said one or more assets that are stored in a database, said one or more Monte Carlo paths comprising at least price and/or volatility information of said one or more assets as a function of time.

In a further embodiment, said method may comprise: executing said executable pricing module, on the basis of at least part of said price and/or volatility information of at least one of said one or more Monte Carlo paths.

In yet a further embodiment, said method may comprise: receiving from said executable pricing module at least part of the payoffs, preferably undiscounted payoffs, associated with said at least one Monte Carlo path.

Hence, methods and systems are provided that use a Monte Carlo paths generator in order to price and value an arbitrarily defined instrument on the basis of encapsulating user-code into a consistent and controlled pricing framework. An executable pricing module may be created in a rigorously controlled and consistent manner, typically as part of a broader pricing tool software solution (a main application). The number of paths used by the Monte Carlo engine and the granularity over time (discrete time-steps) may be configurable to achieve a balance between speed and precision.

In an embodiment, executing said executable pricing module may comprise: loading at least part of said price and/or volatility information, preferably on a per-path basis, into one or more software-objects, wherein said one or more software-object are accessible at runtime by said executable pricing module.

In an embodiment, executing said pricing module may further comprise: enforcing said one or more paths to conform to the requirements set by instrument definitions.

In an embodiment, executing said pricing module may further comprise: processing said price and/or volatility information in one or more Monte Carlo paths so that said price and/or volatility information is available for every point in time required by instrument definitions and instrument parameters.

In an embodiment, said method may further comprise:
determining the payoffs for said one or more Monte Carlo paths; determining the discounted payoffs by performing operations of discounting and, optionally, changes of numeraire, in accordance with instrument definitions for each of said payoffs; determining the price and, optionally, the sensitivities of said user-defined financial instrument on the basis of said discounted payoffs; reporting said value and, optionally, said sensitivities to a graphical interface or to a database in a format that is consistent with instrument definitions.

The framework may use Monte Carlo techniques to compute the value and the sensitivities of a user-defined product. It is widely recognized that Monte Carlo methodologies (in contrast to other methodologies such as lattices and finite differences) are the only ones truly capable of handling any arbitrary product especially when such product would exhibit a high degree of ‘path-dependency’.

Furthermore, Monte Carlo methodologies may handle effectively high-dimensionality, for example when the value of a contingent claim depends on the joint behaviour of several assets. And any reasonable pricing model can be effectively modelled and represented in Monte Carlo, even when such model presents a number of advanced features, such as stochastic volatility, local volatility, stochastic interest rates, jumps, etc. Because Monte Carlo methodologies are the only ones truly capable of pricing an arbitrary instrument on an arbitrarily complex pricing model, the core pricing engine of the invention may rely on such techniques.

When implementing the invention, the pricing system may be capable of handling market data (such as spot values, interest rates curves, volatility surfaces and cubes, etc.) and implementing a number of pricing models (such as Heston, Stochastic-Local volatility, Sabr, etc.) and may have Monte Carlo capabilities. In particular, the pricing system may be capable of ‘calibrating’ models parameters in order to match the market data, both in the case of single asset and in the case of multiple correlated assets. The results of calibrations, in terms of Monte Carlo paths and optimal model parameters may be made available to the framework, for pricing user-defined instruments.

In an embodiment, said method may further comprise:
generating a second user interface, in accordance with instrument definitions, said second user interface being configured for modifying said one or more instrument parameters according to at least part of said instrument definitions.

When a pricing system is deployed following a SaaS (software-as-a-service) business model, the direct expandability also allows the software vendor himself to endlessly expand the products coverage of the system, by writing the code and publishing new products selectively to customer organizations. By using roles and permissions in the pricing system under the control of the software vendor, the process can be organized in an orderly fashion, so that the formal steps of ‘releasing’ a new product can still be followed by each customer organization. Indeed, internal compliance rules for ‘releasing’ a new product may vary within each organization. Clearly, in a SaaS deployment scenario, products defined by a customer organization preferably should remain private to said organization and not visible by other organizations, since user-defined products often provide competitive advantages that an organization may retain.

Once a new product has been released, the pricing system may be able to handle all the processing of such product at par with other traditionally pre-defined products, especially in terms of pricing, revaluation, risk management, risk analysis, management of life-cycle, reporting, auditing, settlements, etc.

In an embodiment, said method may further comprise: enforcing controls based on instrument definitions to the outputs of the computation of such code, designed to maintain global consistency;

In an embodiment, said method may further comprise: computing, where applicable, the value of ‘holder choices’ by backward induction, including the case of non-European option styles.

In an embodiment, said programmatically-generated code wrapper and user-defined code may be merged for the purpose of at least one of: pricing the instrument and its sensitivities; enforcing user-defined validation conditions on inputs; defining alternative payoffs as a consequence of ‘holder choices’ and by extension the choices of early exercise in the case of non-European option styles; pricing a control instrument to be used for correcting the value or boundaries of the main instrument; computing extra information and debug information.

In an embodiment, depending on instrument definitions and user-inputs of a specific instrument, Monte Carlo paths may be processed at least for the purposes of: filling time-gaps so that Monte Carlo data are available for every date required by instrument definitions; and/or, handling Monte Carlo data relative to specific spot references.

In an embodiment, variable types, enumerators, variables representing nationals and special software objects may be provided to handle inputs consistently in accordance with said instruments definitions. Dedicated software objects may be implement ed both in a ‘static’ and ‘dynamic’ version. Objects and variables may be defined as scalar or as arrays.

In an embodiment, said instrument definitions are used for enforcing global consistency by construction.

In an embodiment, past events, such as past fixings, observations of trigger conditions, etc. may be properly and consistently managed, therefore ensuring a correct handling of the entire life-cycle of an instrument.

In an embodiment, said instruments and their full definition and description may be stored to and retrieved from a database. In an embodiment, storing and retrieving may be based on permissioning rules that may include at least a combination of organizational level, user role and/or the stage of such instrument in the process of formal release.

In an embodiment, the method may allow a user to define instruments for the benefit of customer organizations and publish them selectively to users and organizations on the basis of a combination of at least the organizational level, user role and the stage of such instrument in the process of formal release of each target organization

In an embodiment, the input values required to defining an instrument or a portfolio of instruments may be stored and retrieved from a database, validated, priced and aggregated either in memory or into a further database or displayed in a graphical interface.

In an embodiment, different actions may be taken in different contexts, such as ‘pricing at inception’ or ‘revaluation of existing deal’. Validation rules may be enforced differently in different pricing contexts.

In an embodiment, method may handle instruments depending one or more assets or ‘underlyings’ and different ‘asset classes’; and, by extension, handle also ‘hybrid’ instruments.

In an embodiment, one or more software objects representing at least dates and schedules may be populated with values of a Monte Carlo path and are made visible to user-code on a per-path basis. Methods are provided to enforce a read-only visibility from the point of view of user-code.

The invention may further relate to a system for creating and pricing a user-defined financial instrument, wherein said system may comprise: a computer readable storage medium having computer readable program code embodied therewith, and a microprocessor coupled to the computer readable storage medium, wherein responsive to executing the first computer readable program code, the processor is configured for executing computer readable program code of a main application, said program code being associated with an object-oriented programming language, preferably VB.net, C#.net or an equivalent thereof, that comprises one or more compiler classes.

In an embodiment said program code may be configured for: providing a first user interface for receiving instrument definitions and user-code defining the contingent cashflows of at least part of a user-defined financial instrument as a function of at least part of said instrument definitions; receiving said user-code and at least part of said instrument definitions from a user interacting with said first user interface, said instrument definitions comprising at least an instrument name and one or more instrument objects and said user code comprising semantic expressions in accordance with the syntax of said object-oriented programming language; using said instrument definitions for programmatically generating a code wrapper in accordance with the syntax of said programming language, said code wrapper comprising semantic expressions configured for orderly passing of at least part of said instrument objects to corresponding instrument parameters in said user code and orderly returning output objects representing contingent cashflows values; combining said user code and said programmatically-generated code wrapper into a derived source code; and, compiling said derived source code, preferably at runtime, into a derived executable code by invoking said one or more compiler classes of said object-oriented language.

Hence, a high-level object-oriented programming language may expose its own compiler as a class and may further handle the resulting code that is compiled on the fly as an object. This functionality may be used by a financial software application (a main application) wherein the application renders a graphical user interface that allows a user to define at runtime some arbitrary financial instrument using the object-oriented programming language, compile it on-the-fly in the computer memory, execute it (while optionally passing some parameters) and receive back in the main program the results of such user-defined computations.

In an embodiment, said program code may be further configured for: selecting a pricing model for describing the evolution over time of the price and possibly the volatility of one or more assets on the basis of one or more stochastic processes, the value of said user-defined financial instrument being derived from the evolution over time of said one or more assets; using said selected pricing model for generating one or more Monte Carlo paths on the basis of current market data of said one or more assets that are stored in a database, said one or more Monte Carlo paths comprising at least price and/or volatility information of said one or more assets as a function of time; and, executing said executable pricing module, on the basis of at least part of said price and/or volatility information of at least one of said one or more Monte Carlo paths; and, receiving from said executable pricing module at least part of the payoffs, preferably undiscounted payoffs, associated with said at least one Monte Carlo path.

In an embodiment, said program code may be further configured for: loading at least part of said price and/or volatility information, preferably on a per-path basis, into one or more software-objects, wherein said one or more software-object are accessible at runtime by said executable pricing module.

In an embodiment, said program code may be further configured for:
determining the payoffs for said one or more Monte Carlo paths; determining the discounted payoffs by performing operations of discounting and, optionally, changes of numeraire, in accordance with instrument definitions for each of said payoffs; determining the price and, optionally, the sensitivities of said user-defined financial instrument on the basis of said discounted payoffs; reporting said value and, optionally, said sensitivities to a graphical interface or to a database in a format that is consistent with instrument definitions.

The invention may also relate to a computer program product comprising software code portions configured for, when run in the memory of a computer, executing the method steps as described above.

When compared with methods and systems in the prior art, the invention provides the following advantages:
Control and granularity on user-defined-code, embedded as standard object-oriented code
The possibility to write user-code in a number of different well known languages (such as VB.net and C#.net)
Object-oriented code is easy to control and understand even when the code is highly complex and contains a number of conditions
No requirements for external developing tools or integration tools
A very performing framework, typically much faster than other solutions
A strictly controlled environment that ensures consistency of definitions and pricing
A framework that can work for single and multiple assets instruments and for assets belonging to different asset-classes (hybrids)
A framework that is capable of pricing arbitrarily defined instruments on the most advanced pricing models, irrespective of the complexity of such models
A framework that is capable of handling automatically instrument pricing all along the life-cycle of an instrument
A framework that can work appropriately in many contexts, such as a pricing, revaluing, simulating, back-testing, etc.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1 depicts a process for generating calibration parameters and Monte Carlo paths that are used during the pricing an instrument.

FIG. 2 depicts a high-level diagram of a pricing system according to an embodiment of the invention.

FIG. 3 depicts the management of instrument definitions according to an embodiment of the invention.

FIG. 4 depicts a schematic of string manipulation for generating a programmatically generated source code for the purpose of pricing such instrument according to an embodiment of the invention.

FIG. 5 depicts a schematic of string manipulation for generating a programmatically generated source code for the purposes of input validation according to an embodiment of the invention.

FIG. 6 depicts an example of the general scheme of visibility of classes according to an embodiment.

FIG. 7 depicts such validation by invoking the compiled user-code and the validation subroutine.

FIG. 8 depicts the preparation and manipulation of Monte Carlo paths based on a selected financial model, instrument definitions and other user inputs according to an embodiment of the invention.

FIG. 9 depicts provisions to enforce a globally consistent pricing framework according to an embodiment of the invention.

FIG. 10 depicts the population of date objects at pricing time on a per-MC-path basis according to an embodiment of the invention.

FIG. 11 depicts a general scheme for the handling of complex objects, such as trigger's continuity adjustments according to an embodiment of the invention.

FIG. 12 depicts processes taking place after invoking user-defined code, such as discounting and aggregating Monte-Carlo paths results according to an embodiment of the invention.

FIG. 13 depicts a block diagram illustrating an exemplary data processing system that may be used in this disclosure.

### DETAILED DESCRIPTION

While most of embodiments in this application will describe financial instruments that depend on a single asset (such as a ‘vanilla’ option), the invention is not limited thereto and also applies to instruments that depend simultaneously on many assets (such as a ‘basket’ option). Some further specifications will be provided for the case of instruments depending on multiple assets.

Similarly, while most embodiments in this application focus on currencies (the so called ‘forex’ or FX asset class), the invention is not limited thereto and applies to any asset class (such as equities, interest rates, commodities, etc.). Some further specifications will be provided for the case of different asset classes. The invention is also applicable, by extension, to instruments that at the same time depend on many assets and such assets belong to different asset classes (so called ‘hybrid products’).

While the invention is applicable to any software programmed in an object-oriented language capable of exposing its own compiler as a class, the description will focus on the Microsoft .net framework and specifically on the Visual Basic language (also known as ‘VB.net’). The VB.net language is capable to expose as a class (part of the ‘CodeDom’ namespaces) the compilers of several languages that are part of the Microsoft .net framework (for example VB itself or C#).
As the .net framework may expose a compiler as an object, the compiler itself may be ‘used’ by a program: the pricing system (the main application) may access the compiler, assign its properties and perform its methods. The pricing system may regard the ‘source code to be compiled’ as a string. The pricing system may be configured to programmatically form strings that are meaningful to the compiler and merge them with the string that represents user-defined code. This way, a programmatically-defined source code representing a user-defined instrument may be defined and executed by the pricing system.

As a result, in an embodiment, the pricing system may be created in one programming language (a first programming language, such as VB.net) and users may write their user-code in another language (a second programming language, such as C#). The final result from the point of view of the final user is the possibility to choose in which of the languages to write its own code. Nonetheless, for sake of clarity, in this disclosure both the main software application (the pricing system) and the user-code are written in VB.net.

While the implementation of the different components of the invention may be executed on different hardware or virtual machines connected by a network, with several different possible configurations of work balance among the physical or virtual machines, for simplicity for the main embodiments described in this specification components are run on the same hardware or virtual machine.

While the invention applies to all scenarios where the value or the sensitivities of a user-defined instrument are required (such as pricing, position keeping, simulation, back-testing, etc.), the description is focused on the case of the pricing of a single instrument at inception. Evidently, other embodiments can be implemented in most cases just by pricing simultaneously or under different conditions a collection of instruments.

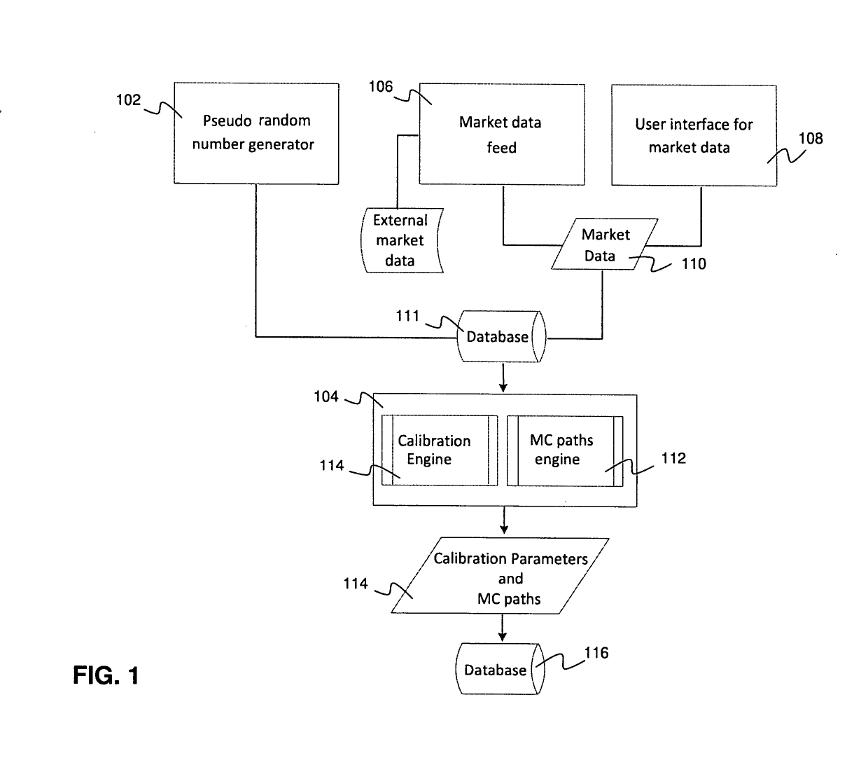

FIG. 1 depicts a process for generating calibration parameters and Monte Carlo paths that are used during the pricing an instrument. The system (a ‘vendor’ will be referred to as the developer of such software, irrespective of whether such solution is commercial or ‘in-house’) may comprise at least a pseudo-random number generator 102 to be used in conjunction with a Monte Carlo engine 104, an electronic feed 106 and/or a user interface 108 to provide up-to-date market data 110 (such as the spot value of the relevant assets (i.e. the current market price at which an asset is bought or sold for immediate payment and delivery), zero-coupon interest rates curves of different currencies and different credit grade, volatility surfaces or cubes applicable to all the relevant assets, matrixes of correlations among the relevant assets, etc.), one or more databases 111 where information may be conveniently stored, a Monte Carlo paths generator 112 configured for representing different pricing models, such as stochastic volatility models, both for a single asset and for the joint behaviour of multiple assets. Here, the volatility may be defined as a measure for variation of price of a financial instrument over time. Different pricing models such as Sabr, Heston, SLV, etc. are known in the art and are based on a number of different assumptions.

The Monte Carlo paths generator may be configured for providing a so-called Monte Carlo (MC) path as an output. An MC path may comprise relevant information over a certain time period. Path-related information may include e.g. asset price (spot price) and volatility of an asset. Path-related information may further include asset(s) price(s) before and after asset-jump(s), volatility(ies) before and after a volatility-jump(s), interest rates or discount factors before and after interest-rate-jump(s).

Once a particular pricing model is selected, it is calibrated against existing market data. Calibration is the process of identifying the set of model parameters of a certain model that are most likely to match the observed data. To that end, the Monte Carlo engine also includes a calibration engine configured for fitting the optimal parameters of the currently selected pricing model on the observed market data (typically by minimizing a measure of error of option prices as compared to option priced on the volatility surface or cube). The system may generate calibration parameters and MC paths 114 on the basis of input variables and store the generated parameters and paths in a database 116.

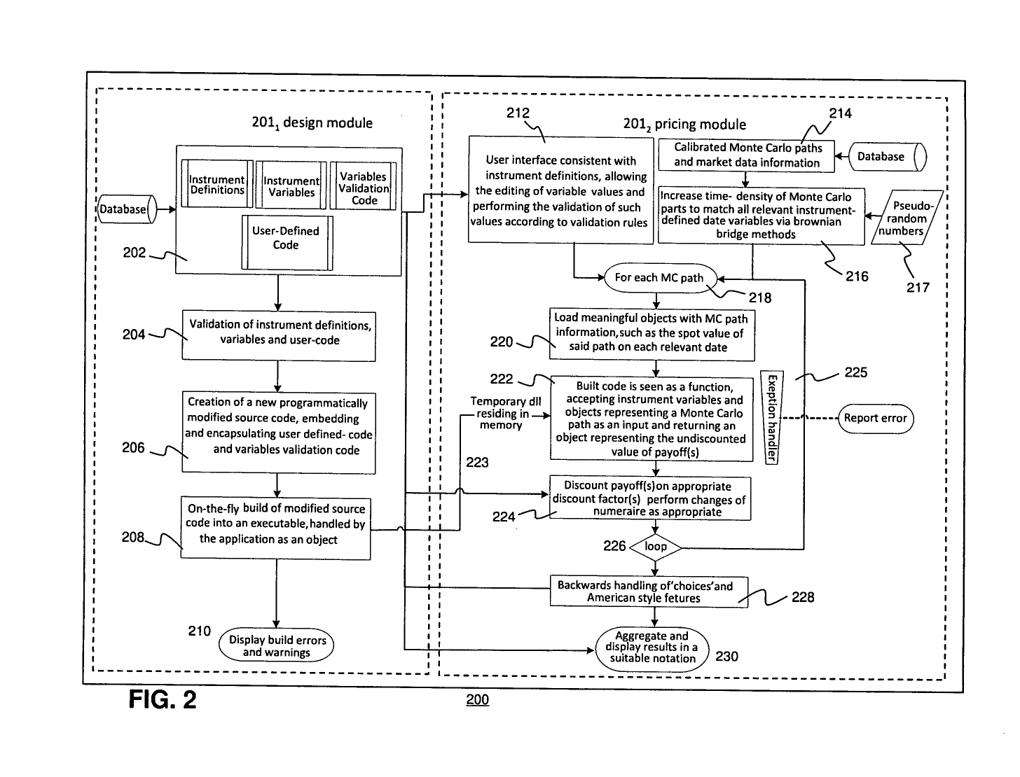

A high-level diagram of a pricing system according to an embodiment of the invention is provided in FIG. 2. The pricing system 200 may be part of a larger software application—the main application—that may be executed on a (special purpose) computer. The main application may be written using an object-oriented language that is capable of exposing its own compiler as a class. In an embodiment, the pricing system may comprise at least two different but related modules:
a) a design module 201₁ for designing and/or editing a user-defined instrument;
b) a pricing module 201₂ for pricing and evaluating a designed user-defined instrument on the basis of input of actual market data and/or specific parameters that are used for defining such instrument (for example, a specific strike price or an expiry date).
The design module may be used in a first phase wherein a user may design (or edit) a user-defined instrument. This phase may be referred as the design time phase (in short “design time”). Thereafter, a second phase may be triggered wherein the pricing module may price and evaluate the user-defined instrument. This phase may be referred to as the pricing time phase (in short “pricing time”).

### Design Time

The design module may be configured to execute a process that allows creating or editing of an arbitrarily user-defined financial instrument. To that end, the design module may be configured to render a graphical user interface (GUI). The GUI may enable a user to create an instrument and store the user-defined in a database and/or to retrieve an instrument from a database and edit it. The GUI may handle description variables, input variables and user-code (step 202).

The user-code that the user enters via the GUI may be regarded by the pricing system a string that is formed on the basis of the rules of a programming language, in particular an object-oriented programming language, that may be used for defining the user-code. The pricing system may store the user-code as a string (hereafter referred to as a user-code string).

Description variables may specify some behaviour of the pricing interface, may define how some calculations have to be handled by the system and how outputs may be presented, etc. Input variables are variables created to host user inputs at pricing time and to handle some special pricing features.

Variables may be defined at least in term of a unique name and a type. Many special types and enumerators may be created by the vendor to facilitate the tasks at hand. Variables definitions also contain provisions as to how to handle a user input at pricing time, for example by setting rules of visibility, or permissions to edit or toggle; furthermore, by showing remarks or instructions for the benefit of the user at pricing time.

In one embodiment of the invention, variables may accept some source code to be interpreted as a validation rule for said variables and an error message to be presented to the user in case the input parameter is invalid according to such rule.

In one embodiment of the invention, variables may accept a second set of rules to further restrict validation in the context of pricing a new instrument at inception. This set of rules may only be applicable in the specific context. For example, a rule may specify that relevant dates defining the instrument may be strictly defined as falling after the evaluation date. Such a rule may be applicable only at inception, but evidently not in other contexts, such as revaluation, whereby, with the passage of time, it is natural that the evaluation date will at one point go beyond the dates defined as details of the instrument.

In one embodiment of the invention, variables also accept some source code to implement a dynamic behaviour of user interface at pricing time.

In the main embodiment of the invention, a special object representing a date or a point in time is made available to the editor interface and the user-code. This object is needed for the implementation of the invention and will be described hereunder in more depth.

In the main embodiment of the invention, objects representing the main elements of an instrument are made available to the editor interface and the user-code. Such objects may be represented by natively defined types in the programming language (such as a ‘double’ or a ‘Boolean’) or specially created types of enumerators, suited for the purpose of the invention.

In one embodiment of the invention, some pre-defined objects are made available by the vendor per the purpose of efficient and controlled handling of a number of features. Such objects expose properties and methods to the user-code and can be used to manipulate an instrument quickly and effectively. A non-exhaustive list of such objects may include:
A fixing schedule object
A single-trigger object
A double-trigger object
An extremum object
A user-choice object

All these objects do require references to dates objects that may exist in the definitions of date objects. For example, a fixing schedule object refers to dates objects representing the initial and final dates of such schedule. For example, a single-trigger object refers to dates representing the initial and final observation dates for such trigger. Validation of objects at design time may check that such reference dates exist. Validation of objects at pricing time (i.e. when the user-defined instrument is priced by the pricing system) may check that effective dates input by user comply with rules set by the object itself. For example, the start observation date of a trigger may always be set strictly before the end observation date of such trigger.

In the design phase, all or at least part of the user inputs, settings and definitions that form the user-code string may be validated according to rules set by embodiments of the invention (step 204). When such validation rules are fulfilled, a programmatically generated source code may be generated by the pricing system. To that end, the user code may be embedded into a programmatically generated code wrapper (step 206).

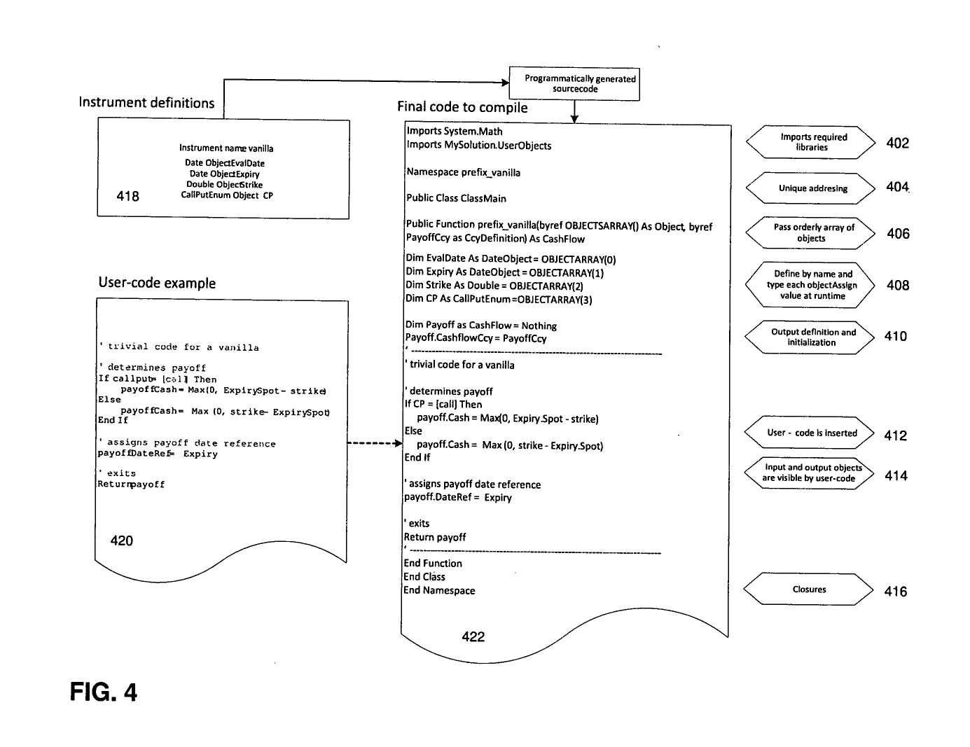

The programmatically generated source code that is created may be formed in accordance with the specific rules of the programming language in object (for example in VB.net) and take into account the consequences of such code on the execution at pricing time. In particular, the programmatically created code wrapper may comprise one or more well-formed strings (i.e. a string that is formed in accordance with the rules of the programming language) that are merged with the user-code string. Hence, the programmatically generated source code may be generated by modifying the user-code string and the programmatically generated code wrapper string on the basis of the instrument definitions, the user-code and the rules of the programming language in which the user-code is written. The details regarding the formation of the programmatically generated sources code is discussed hereunder in more detail with reference to FIG. 4. The programmatically generated code wrapper (string) may comprise:
Definitions for univocally defining Namespaces, Classes and Function names;
Import statements for importing of the Namespaces of the .net framework that are relevant for the purpose of the invention, while excluding other Namespaces in order to limit user-code to acceptable tasks;
Definitions of variables and types that are consistent with user definitions of the instrument;
Variables referencing to inputs objects that comprise the value of such variables when the programmatically generated source code is executed;
Definition and initialization of the one or more output objects that may be returned as a result of an execution;
Definitions of one or more functions that may perform the validation rules at pricing time consistently with validation rules defined at design time.

Thereafter, (step 208), the programmatically generated source code (i.e. a collection of computer instructions possibly with comments written using some human-readable computer language, usually as text, which is the result of programmatic manipulation of strings including the actual user-code and the code wrapper, may be passed to a compiler class for forming an executable. In an embodiment, the methods of the compiler object that forms part of the net framework may be used actually compile the programmatically generated source code (a string) into an executable.

Compilation errors and warnings are reported to the user (step 210). In case of error, the process is terminated and it is not possible to price such instrument. Documentation provided by the software vendor may describe in detail how user-code may be written. In particular, users should be aware of the characteristics of the return object expected by the code, which is predefined by the vendor and enforced in the programmatically created code. Since, normally, compilers do not accept a return object different from what is expected or enforced, in general, the compiler itself mitigates the risk of incorrect or inconsistent user-code. However, more provisions are implemented at pricing time, whereby the pricing system, in particular the pricing module, checks the result of computations in each Monte Carlo path as far as:
A result object exists;
The result object is of the appropriate type;
Each required property of such object has been; explicitly populated by the user-code;
Properties of such object are consistent with instrument definitions.

In case of successful build, the resulting executable object is maintained in memory through a handler, which allows the pricing system to interface with the executable code at pricing time (step 223). Hence, the compiler object may return information associated with the compilation, such as the error status, and a ‘handler’ to the executable code. The handler may be used to launch the executable code after a successful on-the-fly compilation.

### Pricing Time

After the first phase, the pricing module may be executed, which may be configured to render a second graphical user interface (for actual pricing of the instrument) on a display (step 212). Appropriate fields may be created, default values may be initialized, the fields may be made visible or invisible, editable or not editable according to rules and definitions set during design time.

In one embodiment of the invention, the second graphical user interface at pricing time may react differently depending on whether such interface is used in the context of testing a specific instrument or in the context of general pricing of any instrument available and visible by said user.

In the first case (testing an instrument), the second graphical user interface may pre-select the instrument currently being edited and may not allow user to change instrument; this allows testing the actual pricing of the instrument at hand.

In the second case (pricing an instrument), the second graphical user interface may interface with a database to retrieve all or at least some instruments that are available to the user, depending on a combination of the organizational level, the user role(s) and/or the ‘release’ status of the instruments, possibly combining also instruments made available by the vendor. A list of such instruments may be populated and user can choose among them.

When an instrument is chosen, all the aforementioned steps concerning the load from a database of instrument details and its build are performed on-the-fly. However, a user may not see the graphical user interface used for editing the instrument or may be allowed to see it, but not to modify it.

In all cases, when an instrument is selected, the second graphical interface at pricing time is re-created and re-initialized. Furthermore, when an instrument is selected, the graphical interface may allow user to choose the underlying(s), as many as stated in the instrument definition.

At pricing time, a user may interact with the graphical user interface in order to select the underlying assets (for example a currency pair in the case of a single-asset forex instrument), the system may connect to a database and retrieve all the relevant market data for each asset and possibly a correlation matrix dimensioned to host the correlation between each asset and each other asset.

After market data is available, the graphical interface may allow user to possibly calibrate one or more assets models in order to match the current market data (step 214).

Since, normally, advanced models do require a calibration process, the graphical user interface may not allow user to price an instrument if at least one calibration is missing or invalid or unsatisfactory. The interface may also provide means for the user to choose different pricing models from a list of models available in the system. Furthermore, a general validation of market data may be performed.

If market data is validated, the graphical user interface may allow the user to enter all the required details to define a specific instance of the selected instrument, for example by entering an expiry date or a strike price.

Every time the user interface is modified by the user, a validation of input field is performed. Such validation is consistent with and driven by the definitions of the instrument provided at design time.

In one embodiment of the invention, the pricing system may validate input fields at two levels. Firstly, by validating the input text or value versus the type of data required for such field. For example, by validating that a field associated with a numerical variable contains a sequence of characters that can be correctly parsed into a number.

Secondly, by invoking and executing the part of user-code relative to variable validations. When such code would return an exception, the graphical user interface may display the associated error message and forbid to price the instrument.

In one embodiment of the invention, the graphical user interface may implement special handling of some special objects, such as fixing schedules, arrays and notional amounts. In one embodiment of the invention, the graphical user interface may contain provisions for special handling of non-deliverable currencies, for example by forbidding user to select the payoff of an instrument in a non-deliverable currency.

In one embodiment of the invention, the graphical user interface may allow users to select a fixing source in case of an instrument that is cash settled, which in turn depends on the definitions at editing time. In such case, the graphical user interface may read from a database a list of fixing sources available for a specific currency pair or a group of currency pairs and allow user to select from such list. Upon selection of a source, the interface may load from a database a list of invalid fixing days (for example holidays in a certain country) and validate that any date that is relevant for the pricing of the instrument (including dates that are part of a fixing schedule and other objects implementing or referring to dates) falls on a valid fixing day.

In one embodiment of the invention, the graphical user interface may handle the notional amount(s) by following rules set by the description of the instrument at design time.
For example, an instrument may have been defined as allowing an exchange of notionals (such as a ‘vanilla’ FX option), whereby the ratio of the notionals expressed in foreign and domestic currency is set by the strike. Therefore, the graphical user interface would show both notionals and maintain their relative value in proportion to the current strike automatically, provided such strike has a valid and positive numerical value.

In the case of instruments whose notional is a payoff in a specific currency, the graphical user interface may allow to specify the notional in the currency that is currently selected by the user at pricing time. The notional value entered by the user is then used in conjunction with the definitions of the instrument to perform premia computations consistent with the price notation.

Upon successful validation, the pricing system may perform the evaluation of the specific instance of the instrument on the selected calibrated model using the current market data.

The computation of the actual price of a specific instrument (characterized by specific details) may require one or more process steps, which are described hereunder in more detail.

The system may generate a list of all relevant dates. Such list may include by definition the ‘EvalDate’ that is enforced by the system, any other date object, any date that is referred to or generated by other objects. For example, all dates generated by the ‘fixing schedule’ object, start and end observation dates of triggers and extrema objects. Once such list is generated, the pricing system may produce a derived list of dates that may be unique (avoid duplications) and ordered in time. The system may also verify that no date falls after the last date available in the Monte Carlo calibrated paths and parameters retrieved from the database.

The list of ordered required dates is then compared with the ordered list of dates for which a calibrated Monte Carlo simulation is available. In general Monte Carlo simulation may not include every possible date, but rather be performed on a given time-step. The system may then ‘fill the gaps’ for each Monte Carlo path, so that there exist a Monte Carlo simulation matching all relevant dates, by using Brownian bridge or other techniques, which can be performed recursively (step 216).

Importantly, such techniques may be performed by taking into account the evolution over time of assets on known calibrated points, the volatility (which may be unique to each path and time-step) the existence of jumps and other factors, all of which are retrieved from the database as part of the Monte Carlo calibrated simulation and calibration optimal parameters.

The technique also makes use of pseudo-random numbers; such numbers may be independent from the pseudo-random numbers used for calibration of Monte Carlo paths, in order to avoid issues with autocorrelation.

For that reason, a separate and independent pseudo-random number generator may be devoted to this particular task. In one embodiment of the invention, this may be achieved by using different pseudo-random numbers generators with pre-defined different ‘seeds’ (step 217). The result of this process yields Monte Carlo paths fully generated for all required dates and at the same time consistent with the calibrated financial model.

Provisions may be implemented to make sure that the Monte Carlo paths are relative to the current ‘spot reference’, which may be set by user and in general may differ from the spot reference used by the calibrated Monte Carlo paths. In one embodiment of the invention, the database returns pre-computed Monte Carlo paths based on a given spot reference. When the pricing of an instrument is required based on a different spot reference (set by the user at pricing time), the Monte Carlo paths may be shifted in a geometric way (using a fixed multiplier based on the ratio of the two different spot references). This process may be consistent with the hypotheses of so-called ‘sticky delta’ behaviour of volatility surfaces.

In one embodiment of the invention, the database may only return the optimal parameters of the calibrated Monte Carlo paths on a given financial model. Monte Carlo paths are then created on the fly at pricing time directly based on the current spot reference (as set by the user), the calibrated optimal model parameters and following the equations of the specified model and using a proper pseudo-random number generator.

A main loop defined (steps 218 to 226) may be started whereby a number of processes are performed on a per-path basis. Such processes are responsible for loading object properties with correct and consistent data, invoking the user-defined code, retrieving, controlling, aggregating and displaying results.

First, a number of data representing each Monte Carlo path may be organized conveniently and indexed (step 218), for example by using arrays representing the evolution over time of assets prices and their volatilities and the presence and size of possible jumps.

Then all objects defined at design time may be handled, by loading meaningful properties in such objects (step 220). For example, the date object exposes properties representing the spot price on such date and for a given path, the discount factors on the settlement date derived from such date applicable for discounting a cash flow in a particular currency, given the interest rates (that may be stochastic) as populated by the Monte Carlo calibrated simulation, factors to represent changes of numeraire as applicable, etc.

Both the Monte Carlo simulation data and the defined and populated objects are then passed to the executable code associated with the user-defined instrument, which is invoked on a per-path basis (step 222). The executable code may be visible by the application and has a variable-passing mechanism that has been configured by the programmatically generated code wrapper and that is consistently with the list of objects to be passed at pricing time.

In one embodiment of the invention, the executable code may be executed within statements capable of capturing exceptions at runtime. A special object representing a user-defined exception may be available to users during editing time and can be thrown programmatically to interrupt the user-code and report an exception to the user at pricing time (step 225). Any type of exception, handled by the programming language in use, can anyway be captured during the time when control is passed to the executable code. Such a provision increases significantly the robustness of the application.

When user-code execution is terminated without exceptions, the control of the program flow returns in the main body, which may control the results that may have been loaded by the user-code into a return object. A number of provisions may ensure that such return object exists and has been populated by the executable code. The return object, named ‘CashFlow’, may represent an undiscounted payoff or a stream of undiscounted payoffs, characterized by the currency in which such payoff is expressed, the cash-flow associated with such payoff and a reference to a date object (which contains pre-loaded information) upon which such cash-flow is paid or received.

Depending on definitions (single payoff versus multiple payoffs), the system may verify the consistency of the object returned by user-code (a ‘CashFlow’ object or an array of ‘CashFlow’ objects).

For each payoff, as required, the system may perform checks on the payoff currency, depending on instrument definitions and settings in the user interface. Furthermore, the system performs changes of numeraire and discounting (by using the information preloaded in the date object that is assigned as a reference by the user-code) depending on instrument definitions and settings in the user interface (step 224).

Discounted payoffs may then be aggregated (on a per-path basis) in order to compute the present value of the instrument in the appropriate currency and with the correct numeraire on such Monte Carlo path. Finally, the present value of the instrument on each Monte Carlo path may be averaged (on all paths) to compute an estimate of the price or value of the instrument as per the evaluation date (step 230).

In one embodiment of the invention, further processing may be performed in the case of instruments that have been designed as having ‘early exercise’ features, such as instruments with ‘American style’ or ‘Bermudan style’. Similar processing may also be performed when the definitions of the instrument include ‘user choices’ objects, which require the knowledge in each Monte Carlo path of the entire distribution of relevant variables at relevant future times.

Under these circumstances, the user-code may return appropriate status variables at each relevant user-choice time. An estimate of the future value of required static variables can be computed by a number of techniques, well known in the art, and the present value of the instrument may be estimated by iterative backward-induction computation. Instruments with a not-European exercise style may be comprised into this paradigm, by observing that such instruments entitle the holder to a number of choices of early exercise.

In one embodiment of the invention, the pricing system may also perform operations to provide an estimate of the so-called Monte Carlo standard deviation, a measure of the error intrinsic in Monte Carlo methodologies. Such measure can then be reported to the final user.

In one embodiment of the invention, some other user-defined information may be reported, as far as computed by user-code consistently with definitions. For example, the prising system may allow the user-code to compute and return the minimum, maximum, average or condition-count of certain control variables. This technique may be used to report to users some extra information at pricing time. For example, an instrument involving a trigger may report the expected time of the first occurrence of a trigger event.

In one embodiment of the invention, some debugging information can be reported, as far as computed by user-code consistently with definitions. This is an embodiment similar to the previous one, but debug information may be reported to final user only depending on a combination of the role of the user (for example, limited to ‘Quant’ role) and/or the status of the instrument (for example, limited to any status not ‘Released’) and/or the visibility of the instrument in the organization, Furthermore, when an instrument is published by the vendor, there may be provisions limiting visibility of such debug results to the vendor itself alone.

In one embodiment of the invention, the described process may be repeated a number of times, by using different input market data (for example a different spot reference) and/or different Monte Carlo simulations data (for example a simulation performed at a slightly higher volatility, all the rest remaining equal), in order to compute instrument's sensitivities (the so called ‘greeks’) in addition to the instrument's value. Such computations may be performed ‘in parallel’ since they are independent, either on the same hardware or on a different hardware provided there exists a network infrastructure that can effectively allow different hardware to interact and synchronize.

Finally, all relevant outputs, such as the price and value of the instrument, the sensitivities (‘greeks’), the Monte Carlo standard deviation and possibly extra user-defined information and debug results may be reported to the user. Depending on definitions at design time and settings at pricing time, outputs may be computed and displayed in a number of formats (for example as a percentage of notional or as ‘pips’ or in absolute value, etc.) and/or may be expressed in different currencies and/or may be represented following different market conventions.

In one embodiment of the invention, negative and positive offsets may be added to the value of the instruments, in order to present bid/ask prices to the user. A number of techniques, well known in the art, may be used to create a reasonable bid/ask price taking as a starting point the mid-price or fair-price, which is yielded by the calculations subject of the invention. However, the price of some instruments is bound to a known domain of existence. Since, in general, applying such offset spreads cannot guarantee ex-ante that the bid price will be above the minimum value allowed for an instrument or that the ask price will be below the maximum value allowed for an instrument, it is possible to define domain boundaries for an instrument as part of the definitions. For example, a ‘vanilla option’ has a lower boundary at zero; an undiscounted ‘digital option’ has a lower boundary at zero and an upper boundary at one. By allowing a user to define boundaries during editing mode in terms of discounted or undiscounted value of an instrument, the system may then be capable of verifying such boundaries are respected at pricing time, both on the fair-price and on bid/ask prices and perform a ‘clipping’ of numerical results.

In one embodiment of the invention, the pricing system may allow the user-code to compute the undiscounted value of two instruments at once, the main instrument and a control instrument. Provisions may be implemented to adapt the programmatically modified code to prepare the source code and take into account the control instrument.

Provisions may be implemented to check and verify the consistency of the result object (which carries information for both the main and the control instruments) and to aggregate appropriately the cash flows of the control instrument using similar techniques as used for the main instrument. A list of instruments is pre-defined by the vendor and functionalities to price such instruments using technologies different from the methods of the present inventions are provided and accessible by the system.

Whenever the control instrument can be associated to one of the pre-defined instruments and the price of the main instrument is guaranteed ‘by construction’ to be a fraction of the price of the control instrument, the value of the instrument using alternative technology and methods (Z) is computed using the accessible library. Both the main instrument (A) and the secondary instrument (B) may be computed using the embodiment of the invention. Then, a final undiscounted price P may be computed as Z*(A/B); finally the other processes described in the invention are performed, such as changes of numeraire, discounting, etc.

This embodiment provides methods to price an instrument relative to the known price of another instrument. For example, the price of a ‘barrier’ option must necessarily be a fraction of the price of an equivalent ‘vanilla’ option. An analytical price can be computed for the ‘vanilla’ option, using well-known techniques in the art, such as pricing such ‘vanilla’ on the volatility surface. However, any instrument priced in Monte Carlo is subject to an error (besides the standard deviation error) that is a function of the calibration accuracy (how precisely options priced in Monte Carlo match vanilla options priced on the volatility surface).

In extreme cases, the price of a ‘barrier’ option priced in a calibrated Monte Carlo may undesirably be larger than the price of the equivalent ‘vanilla’ priced on the volatility surfaces, but can never be larger than the price of the equivalent ‘vanilla’ priced on Monte Carlo itself. Therefore, by pricing in Monte Carlo both the ‘barrier’ and the ‘vanilla’ instruments, the system can deduce the proportion of the undiscounted value of the two instruments (A/B). The final undiscounted price of the ‘barrier’ option may therefore be computed as the vanilla on the volatility surface multiplied by said proportion. This ensures that the ‘barrier’ priced in Monte Carlo maintains consistency relative to more basic instruments priced with other methodologies.

In one embodiment of the invention, a user can choose a ‘direction’ or point of view of pricing (such as ‘long’/‘short’ or ‘we buy’/‘we sell’), at pricing time. While the user-code is conceived to return undiscounted cash-flows always from the point of view of the holder or buyer of such instrument, final results can multiplied by a +1/−1 factor depending on the ‘sign’ or ‘direction’. In most cases outputs may be displayed in a ‘we pay’/‘we receive’ or similar notation in order to avoid ambiguity.

In one embodiment of the invention, further definitions may be applied at design time, specifying that one or more numerical input fields may be defined as ‘solved for’ and one or more outputs may be defined as ‘targets’. This embodiment allows users to seek for the value of an input to match a specified target. Definitions may specify rules of consistency and boundaries of the domain of each variable. The graphical user interface at pricing time may allow users to specify whether a field has a fixed value or its value may be looked for.

The graphical user interface may also allow users to set a target output that is consistent with the rules defined at design time for the field whose value may be looked for. When the rules are respected and the input values are validated, the system may perform the aforementioned procedures a number of times iteratively, by using a numerical procedure such as the Newton secant methodology. Such methodology may incorporate boundaries of the domain of the looked-for variable as well, as specified at design time. While numerical methods are not guaranteed to yield a solution or guaranteed that such solution is unique, in general it is possible to achieve a result within few iterations. Upon a successful matching of the outputs to the target set by the user, the user interface may then report the optimal value of the looked-for variable.

In one embodiment of the invention, the graphical user interface at pricing time may be replaced by a database whereby information describing a specific instrument can be stored and retrieved. A suitable format may be established in order to store information. Any format capable of handling flexibly such information may be suitable, such as XML serialization, bitmap compression of a special object holding properties, etc. In this embodiment the invention can be used in contexts that are similar but different from the pricing context, such as revaluation context, simulation context, etc.

In one embodiment of the invention, many instances of the procedures are invoked in order to price at the same time (sequentially or in a parallel fashion) a multitude of different user-defined instruments, possibly mixing those with other instruments for which other valuation techniques and procedures are used, for the purpose of aggregating the results of portfolios of different instruments. The application may be implemented in such a way that inputs and outputs are consistent among different pricing techniques (including the one subject of the invention), so that aggregation of results maintains internal consistency.

### Creating and Editing a User-Defined Instrument

In one embodiment of the invention, user-defined instruments can be saved to and retrieved from a database, by specifying a unique code-name and numerical ID for such instrument. Any format that permits a meaningful description of the instrument may be suitable, for example XML serialization, Bitmap compression of the properties of a class describing the instrument, etc.

In one embodiment of the invention, an organization is mapped into meaningful hierarchical objects, such as ‘group’, ‘legal entity’, ‘desk’ and each unique user may be attached to one or more objects describing its position in the organization. A description of an instrument may be saved while specifying the visibility level that said instrument may have in respect to other members of the organization. In all circumstances, no user belonging to an organization can have access to instruments saved by members of a different organization.

In one embodiment of the invention, user-roles are defined. A role is a set of rules defining permissions for certain relevant actions in a software system. One or more roles can then be attributed to each user of an organization, in order to control allowed activities. Specific roles can be created, in order to permit to some users to access selectively the creation and editing of instruments (for example, a ‘Quant’ role) and to other users to access selectively the pricing or revaluation of instruments.

In one embodiment of the invention, an instrument carries a status enumerator, describing at what stage of the formal approval such product is. Indeed each organization may have different compliance rules and formal internal procedures for testing and validation of an instrument before this can be broadly used inside the organization. In its simplest form, such enumerator can contain two items, ‘staging’ and ‘released’, whereby an instrument can be edited and tested in both stati, but only a product in the ‘released’ status can be used for pricing and revaluation by members of the organization. In one embodiment of the invention, visibility of an instrument to a user can be determined by combining the status with the user role, thereby limiting the visibility of an instrument to users holding a ‘Quant’ role, when such instrument is in ‘staging’ status.

In one embodiment of the invention, a software vendor offering a solution in a SaaS business model may also create instruments to be made available to users of different organizations. This framework allows a software vendor to improve and expand the system at any time. By using a set of permission flags, a software vendor can selectively make available instruments to different organizations, or to different parts of organizations, or to specific users, or to users holding a specific role. A software vendor may also selectively make available instruments that have a different status (such as the ‘staging’ or ‘released’ status) and align the visibility of said instruments to the specific compliance and validation rules that may exist in each organization and/or to user roles, before an instrument can be effectively used.

In one embodiment of the invention, a graphical user interface is shown to a user for creating a new instrument or editing a new instrument, or loading from the database a saved instrument, or saving a new or existing instrument into the database. Such interface is mostly effective when divided in logical frames and/or tabs so that the logical sequence for defining an instrument is well organized.

In one embodiment of the invention, the following elements of the graphical user interface are created and handled:

### Identification and Description

Such part allows the user to edit at least: a unique codename to identify the instrument, a friendly name to be used at pricing time, a description string, a status variable for permissions (for example a ‘staging’ status versus a ‘released’ status)

The codename may be used to identify the instrument uniquely not only in a database storing a description of instruments, but also for in-memory processing. As a result, such name may be validated according to the rules of the programming language. In the case of VB.net, the codename may be used for defining part of the name of a Namespace, Class and Function in the programmatically-modified source code and must follow declaration rules established by that language. For example, it may not contain ‘white spaces’ or ‘special characters’.

The friendly name is the name displayed at pricing time to identify the instrument and may be clear and not ambiguous. Validation rules can be established to force users to define a meaningful name.

The description string is displayed at pricing time to provide extra information to a user and/or provide some guidance or instructions about the instrument and how to use the input fields that are available for editing.

In one embodiment of the invention, an instrument may carry flags or enumerators, stating its status along the formal process of approval of said instrument for broader use in the organization. Visibility of such instrument to users of the organization can therefore be enforced, depending on sets of rules, which may include the role of the user and the position of the user in an organizational map of the organization.

### Definitions

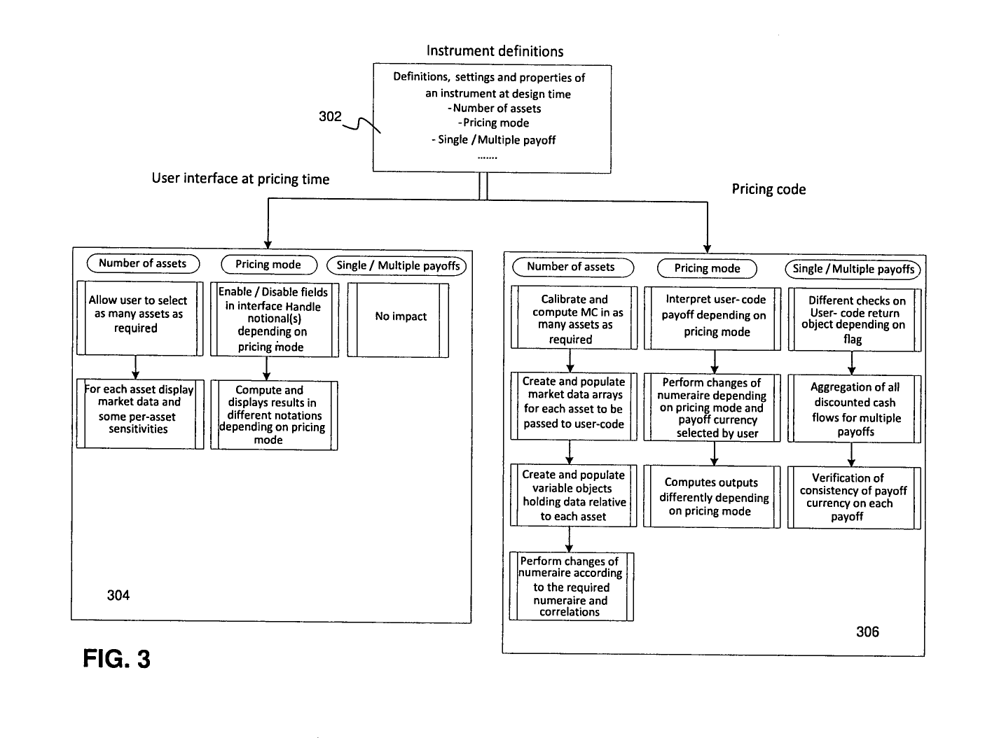

FIG. 3 depicts the management of instrument definitions according to an embodiment of the invention, FIG. 3 further depicts some effects the definitions may have on the pricing code. A part of the graphical user interface that is rendered by the pricing system may expose basic definitions, settings and properties that allow the pricing system to render suitable graphical user interfaces and to evaluate the instrument at pricing time consistently.

Variables holding definitions may be made available to the code handling, the graphical user interface and the code performing the actual pricing. Indeed, pricing system may handle consistently and based on definitions at least and among others: the way user-code may be handled, the way the user interface at pricing time may be handled, the way market data and Monte Carlo processes may be created and handled, the way inner variables holding market data and Monte Carlo paths data may be created and populated, the way object variables passed to the user-code may be created and populated, the way changes of numeraire may be computed and performed, the way a result object may be checked and verified, the way payoffs may be aggregated and discounted, the way outputs may be computed and presented.

In one embodiment of the invention, an instrument may be defined by setting one or more of the following definitions:
a. The number of underlying assets/processes
b. The numeraire currency of the instrument
c. The ‘quantoing’ of the payoff
d. The ‘pricing mode’
e. The payoff currency whether selectable by users at pricing time
f. A single payoff/multiple payoffs flag
g. An option style enumerator
h. Rules to determine a fixing source

In one embodiment of the invention, the ‘pricing mode’ setting defines how the pricing system is expecting user-code to return payoff cash-flows. Such pricing mode may take different meanings for different asset classes. In the example of a single asset forex instrument (an instrument that depends on just one currency pair), the pricing mode may specify in particular whether the cash-flows may be defined in terms of domestic currency (usually referred to as DOM) for each unit of notional denominated in foreign currency (usually referred to as FOR) or in terms of payoff currency (whichever selected by user at pricing time) in terms of one unit of notional of the same currency. In the first case, pricing mode may further specify whether notionals are available in both currencies (and related by which numerical variable, for example the ‘Strike for a ‘vanilla’ option and exchanged on which date, for example the ‘Expiry’ date for a vanilla option) or instead only one notional may be available and used as a basis for calculations (for example, at inception of an ‘average strike’ option, there is no strike price available to relate the notionals). As a function of the pricing mode defined, the graphical user interface and the user code may respond consistently.

One advantage of this approach is the fact that, for instruments whose pricing mode is defined as the payoff of the selected currency for one unit of notional expressed in the same currency, the system has the capability to handle just one unified program code for similar instruments expressed in different currencies. For example, in the case of a ‘digital’ option, which may have a notional and a payoff either in FOR or in DOM, using the aforementioned approach, a user could define uniquely the ‘digital’ option, irrespective of its payoff currency, which can be still toggled at pricing time. User-code may be written abstracting from ‘in which currency the payoff is denominated’, as the pricing system may automatically take care of changes of numeraire and output conversions, consistently and as appropriate.

In contrast, without the knowledge of a ‘pricing mode’ providing to the system essential information about how the user-code is written and how it may be handled consistently, alternative approaches would require a user to define two separate instruments, one for a ‘digital’ with a payoff in FOR and one for a ‘digital’ with a payoff in DOM.

### Date Objects.

In an embodiment, part of the graphical user interface may expose a list of all the date variables that are relevant for the definition of an instrument, Each date object may be identified uniquely by its name. Preferably, at least one date object exists and is pre-defined, the ‘EvalDate’ that carries the evaluation or ‘as of’ date, which is in turn the date from which a Monte Carlo process is started at pricing time for evaluation of the instrument.

At design time a date object may be defined in two ways: ‘date’ and ‘settlement date’, The type has an effect on the user interface and on how an internal special date object is populated.

As far as the graphical user interface at pricing time is concerned, a ‘date’ type may force the system to perform validations on the trading date, for example raising warnings if such date is a Saturday or Sunday or, when the pricing is performed on a cash-settled instrument based on a fixing, raising warnings or errors, depending on the severity of the condition, when such date falls on an invalid fixing date. For a ‘settlement date’, validation checks may be performed on appropriate calendars (single or joint) to establish whether such date input by the user is a valid settlement date for the instrument and for the selected asset(s) and currencies.

Validation rules can be edited, specifying the relative position of each relevant date. Rules can be arbitrarily complex and involve any number of other variables.

In one embodiment of the invention, a user may also define default ‘tenors’ for each date variable, by entering a ‘tenor code’ that may conform to some conventions. At pricing time and during the initialization of the user interface, if a default tenor has been specified, a corresponding date is generated and written in the user interface, following the rules, conventions and calendars of the currently selected asset(s) and currencies.

In the main embodiment of the invention, the internal date object is a complex class that carries both information about the ‘trading date’ and the ‘settlement date’. Therefore, when a date variable is defined as ‘date’, the trading date is available directly and the corresponding settlement date is computed, at pricing time, forward from the trading date, following the relevant market rules and appropriate calendars; when instead a date variable is defined as ‘settlement date’, the settlement date is available directly and the corresponding trading date is computed, at pricing time, backwards from the settlement date, following the relevant market rules and appropriate calendars.

Furthermore, the internal date object may carry all or at least part of the information relative to the Monte Carlo simulation (on a per-path basis), such as the evolution of the spot price of an asset on said date and also all the information required to perform changes of numeraire and discounting, such as the discount factors in each relevant currency for an asset. In the case of multiple assets, the date object carries all the information for each asset. In the case of instruments that have a full yield curve as an ‘underlying’, a date object must carry a whole term-structure of yields (represented as an array) instead of an asset price (represented as a scalar).

### Fixing Schedules Objects.

In an embodiment, part of the graphical user interface may expose a list of schedules variables, which may be used to define arrays of dates and fixings, and optionally weights.

A schedule object may refer to existing date objects to define the starting and ending date of a fixing schedule. Both date objects referred may be of the ‘date’ type, ‘settlement’ types are not allowed.

In one embodiment of the invention, a user may also specify a default ‘frequency’ of the schedule, a list of allowed or forbidden frequencies (in respect of a pre-defined list of possible frequencies) and flags controlling how the schedule may be presented to a user at pricing time.

At pricing time, a schedule object may dynamically create arrays of fixing dates, as a function of the values entered in the date fields referenced by the schedule object. Such arrays of fixing dates may be created according to rules, conventions and calendars that may depend on the currently selected asset(s) and currencies. The user interface may also allow a user, at pricing time, to ‘open’ a schedule and display the list of dates, weights, past fixings if available, and any other relevant information; and allow such user to edit both the schedule rows (the dates) and other inputs on each row, as applicable by the definitions of the schedule. Obviously users may never be able to edit the start and end date of a schedule, since these are references to date objects already edited in the user interface.

Internally, a fixing schedule object is an object that exposes an array of date objects, as defined for the date variables. At pricing time, each of the date objects contained in a schedule object is populated dynamically by the pricing code.

In one embodiment of the invention, a flexible schedule may be introduced. A flexible schedule may contain additional arrays of different types (such as doubles, enumerators, Booleans, etc.) associated with each date of the schedule. A flexible schedule may allow users to edit the additional array fields at pricing time and provide rules for the validation of such inputs. The programmatically modified user-code may take care of an orderly passing of parameters, initialization and population of the additional arrays.

Furthermore, the flexible schedule object may expose to the user-code the value of such arrays for processing.

### Parameters Objects

In an embodiment, a part of the interface may expose other variables, which may be used to define the required inputs of an instrument. Variables of different types may be defined, some as ‘native’ types, some as enumerator types created and pre-defined by the vendor for purposes that are specific to the invention.

In one embodiment of the invention, the pricing system may accept at least one or more of the following types:

| | |
|---|---|
| Double | (native type) |
| Integer | (native type) |
| Boolean | (native type) |
| CallPutEnum | [Call, Put] |
| AboveBelowEnum | [Above, Below] |
| TriggerDirectionEnum | [Up, Down] |
| TriggerTypeEnum | [KnockOut, KnockOn] |
| DoubleTriggerTouchOrder | [FirstUpThenDown, FirstUpThenDown] |
| MinMaxEnum | [Minimum, Maximum] |
| FlexEnum | [(user-defined members)] |

In one embodiment of the invention, a user may define, at editing time, whether the field corresponding to a variable may be visible or not visible in the user interface, at pricing time; and in case of a visible field, whether user may be allowed to edit/toggle such field or not. For the Boolean type and all enumerators, a default value may be provided, while for other types such default value may or may not be provided. In some cases, a notation is provided to compute a default value not in absolute terms, but rather in proportion to other variables, for examples as a proportion of the spot reference value of the asset(s) at pricing time.

Validation conditions may be imposed by the user at design time, as complex as desired. Such conditions may involve any other defined variable of any type.

In one embodiment of the invention, a user may define its own flexible enumerator and use it as a variable type, for the purpose of facilitating the comprehension of user inputs. Such enumerator is always converted into an ‘integer’ variable, for processing purposes.

In one embodiment of the invention, parameter objects may be defined as arrays of a fixed dimension or of a dynamically defined dimension. When a parameter object is defined as an array instead of scalar, the programmatically modified user-code (i.e. the user code that is embedded in the programmatically code wrapper) may take necessary provisions to allow an orderly passing of such parameters, their initialization and population in user-code. Furthermore, the pricing system may expose the indexed element of such arrays to the user-code. Finally, the graphical user interface at pricing time may allow the user to edit the fields of each element of the array and perform validation on each element. Object parameters may therefore be defined both as scalar and as arrays.

### Triggers and Extrema Objects

In an embodiment, a part of the graphical user interface may expose a list of special objects, which may be used to define some characteristics of an instrument. While it would be perfectly possible to handle a trigger or an extremum by mean of observing the daily spot price of each asset, it may nevertheless be much more efficient from a computational point of view and more correct from a theoretical point of view to perform so called ‘continuity adjustments’. In one embodiment of the invention, therefore, special objects may be made available by the vendor, for the purpose of simplifying the tasks of handling some complex and rather common features.

Single trigger objects may be defined by referencing the start and end observation dates, a reference to a variable hosting the trigger level, and references to other variables specifying the type and direction of such trigger.

Double trigger objects may exist in two fashions: regular double triggers, whereby it is irrelevant the order with which the two trigger levels are observed; sequential double triggers, whereby a trigger event is raised only when triggers are hit following a specific order or sequence in time. Depending on the case, the definition of a double trigger object may include references to start and end observation dates, references to variables hosting the lower and upper trigger levels and references to other variables specifying the type, required sequential order, etc.

Extrema objects are used to estimate the minimum or maximum value of the evolution of an asset price in a period of time and can be defined by setting references to a start and end observation date, a current minimum/maximum if applicable, and other references to enumerators describing the type of extremum to be observed.

For all objects, validations are performed at pricing time, to ensure start observation dates are always strictly falling before end observation dates.

Internally, these objects are handled by some special classes that provide methods to observe triggers and extrema, taking into account continuity adjustments that may depend on the Monte Carlo variables on each path and exposing properties that are visible in the user-code.

In one embodiment of the invention, trigger and extrema objects can be defined as ‘static’ or ‘dynamic’. An object is considered static whenever its definitions are constant and pre-defined in all Monte Carlo paths. In this case, the system will automatically execute the relevant methods on a per-path basis and expose the output properties to the user-code. In contrast, an object is considered dynamic when some of its properties, for example the barrier level, may be different on different paths, or may be conditional to other circumstances on a per-path basis. In this case, the system will only pre-load the object on each path with the relevant information and it is devolved to user-code to invoke methods and collect back properties on a per-path basis; special provisions make sure that user-code cannot legitimately read properties of these objects, if the methods generating such properties have not been explicitly invoked and performed successfully.

In one embodiment of the invention, the single and double trigger objects contain methods to optionally compute and make available to user-code the ‘first trigger date conditional to a trigger event’, which is internally represented by a date object whose properties are computed by the system on a path-by-path basis. Because a date object carries all information required for the proper changes of numeraire and discounting functionalities, by attaching such an object to a CashFlow output object, it is possible to create very easily an implementation of instruments such as the ‘instantaneous one-touch’ option.

### Choices Objects

In an embodiment, a part of the graphical user interface may expose variables assigning choices to the holder of the instrument, such as the choices to early exercise, the choice to ‘call and redeem’ an instrument, the choice of type of an instrument (for example, a Call/Put choice in the case of a ‘chooser’ option), the choice of buying or selling another instrument (for example in the case of ‘compound’ options), etc.

Choice objects may necessarily refer to an existing date object, specifying the time of such choice. Furthermore choice objects may refer to an object parameter handling the type of choice, typically an enumerator type. Choice objects may also refer to secondary payoff variables to be handled by user-code.

Choice objects may be processed by the application after performing the main Monte Carlo pricing loop, by estimating the future values of possible choices (as defined in user-code by the payoff and secondary payoffs objects) and estimating backwards the value of the instrument in time, choice by choice.

In one embodiment of the invention, special provisions are taken to handle an ‘American style’ option, whereby the system automatically generates inner choice objects properly configured for the task and assigning as many inner objects as existing dates in the Monte Carlo simulation. A ‘Bermudan style’ option can be handled automatically, by generating choice objects attached to each date of a schedule object, which may be specifically configured to host early exercise discrete dates.

### Source User-Code Editor

In an embodiment, part of the graphical user interface may allow a user to write and edit user-code at design time. User-code is retrieved from the editor in the form of a string. In one embodiment of the invention, such editor may implement a number of features designed to facilitate a user to write user-code, such as:
a. Numbering of lines
b. Using different colours for keywords, types, remarks, strings, etc.
c. Auto-filling the name of defined variables and existing types
d. Performing some indentation on the code
e. Exposing methods and properties of objects graphically

### Compiler Outputs.

In an embodiment, part of the graphical user interface may report the possible errors, warnings and messages from the language compiler. In the case of most compilers and certainly in the case of net languages, the compiler reports outputs containing a reference to an orderly ‘line-number’.

In one embodiment of the invention, the line-numbers possibly reported by the compiler's output are adjusted by the application to take into account that a known number of lines of actual source code have been inserted and manipulated in the form of programmatically generated code. Such adjustment of reported lines allows a user to compare directly and consistently line-numbers appearing on the code editor with line-numbers reported by the compiler's outputs.

### Building the Executable Code

FIG. 4 depicts a schematic of string manipulation for generating a programmatically generated source code according to an embodiment of the invention. As already shortly described with reference to FIG. 2, the programmatically generated source code 422 may be formed by string manipulation of the user-code string 420 and one or more programmatically-generated code wrapper strings. Evidently, such string manipulations are performed in accordance with the syntax of the programming language that is used for generating the source code. In FIG. 4 an example of such string manipulation is shown for a simple ‘vanilla’.

At design time (i.e. the phase where the source code is created and edited)—provided the user interface has validated all the elements defining an instrument—the application may compile the programmatically generated source code, in order to create an in-memory executable and perform the actual pricing of the instrument.

The pricing system may use all or at least part of the information in the definitions 418 of an instrument to embed user-code 420 into a programmatically-generated code wrapper on the basis of the rules of a selected programming language. During the generation of the code wrapper different expressions or statements may be inserted in the code wrapper. These are described hereunder in more detail.

### Importing Required Libraries

A programming language may contain statements concerning the syntax of accessing libraries and classes, most often by the use of ‘imports’ or similar statements. The pricing system may therefore generate a code wrapper on the basis of the instrument definitions comprising expressions that allow the user-code to access, e.g. import, the required libraries and classes (step 402). Further, the code wrapper may comprise a module ‘UserObjects’, that may contain classes defining the user objects that can be accessed by the user-code. The code wrapper may also comprise components of the language framework, such as the ‘Math’ class, that may be imported into the source code.

### Limiting the Capabilities of Arbitrary User-Code

The pricing system according to the invention allows the creation of user-defined instruments into a software application for the specific purpose of pricing financial instruments. Thus, it may be desirable to limit the scope and capabilities of user-code to such purpose and avoid the possibility that a user may write and execute arbitrary code that may be harmful or malicious. Enforcing limitations may be achieved by the vendor in many ways, depending on the rules and syntax of the programming language.

In the example of VB.net the vendor could certainly avoid to import libraries that have no purpose in pricing financial instruments (such libraries can therefore be accessed only by referring to the ‘system’ root library) and subsequently analysing the user source code and forbidding the use of the ‘system.’ syntax. Furthermore, limitations can be enforced by implementing ‘white lists’ and/or ‘black lists’ of libraries and classes exposed by the programming language.

### Unique Addressing

In an embodiment, the name defining an instrument e.g. Vanilla, may be selected to be unique and has a format that meets the rules of the programming language (step 404). This may allow the use of the instrument name to address univocally every element that may be unique in a language's framework. In the case of VB.net, for example, the application may define univocally the Namespace, the Class and a number of functions for pricing and input validation.

### Passing Orderly Instrument Objects Values to User-Code

The application creates a programmatically-modified code wrapper in order to perform the orderly passing of the objects values defining an instrument to the user-code, to define all variable names consistently (in terms of name and type) with the instrument definitions; and/or, to populate each variable with the correct object value passed at pricing time (runtime). Hence for each input object, a matching variable with appropriate type is defined and a value is assigned to it from orderly input objects (steps 406 and 408). Such variables are visible by user-code and conform the rules of the language. Further one or more output objects are defined and initialized (step 410). Such output object is visible by user-code and conform the rules of the language. The user-code may populate such output object according to the type of instrument.

For example, in FIG. 4, an array of four objects (EvalDate, Expiry, Strike, CP) may be passed to the user code and therefore a list of four statements is created programmatically, each defining variables that have an appropriate name and type (which in turn depends on the instrument definitions) and whose value is orderly parsed from the input object array.

Such array may be consistently populated by the pricing application at pricing time (by taking the actual input values as entered by a user in the graphical user interface) and passed to the user-code.

So, the code wrapper may comprise expressions that allow a coherent mechanism of passing object variables to the user code. This way the programmatically generated code wrapper provides consistency between the instrument definitions, the building of programmatically-modified source-code, the population of actual values at pricing time into the object variables and the parsing of such values into the compiled user-code.

### Output Definition and Enforcement

The code wrapper may comprise a definition and initialization of the output object (step 410). In the example of FIG. 4 the output object is the ‘CashFlow’ object. Depending on instrument definitions, the output object may be a single ‘CashFlow’ object or an array of such objects. The application would therefore state the output of the pricing function and define the output object differently, depending on instrument definitions.

In one embodiment of the invention, a ‘PayoffCcy’ may also be passed into the pricing function and populated automatically at pricing time, depending on user choices in the graphical user interface. Such value is used to automatically define the currency property of the ‘CashFlow’ object. Consistency checks are furthermore introduced at pricing time, to verify that the output of user-code is consistent in terms of payoff currency with the inputs and instrument definitions.

### Embedding User-Code

The user-code string 420 may then be appended to the programmatically-generated code wrapper string(s). Further, one or more closure expressions that are required on the basis of the syntax of the programming language (step 416) may be added to programmatically-generated source code. In an embodiment, the code wrapper string may be added as a “header” and a “footer” to the user-code string (i.e. the closures 416 in FIG. 4).

User-code may be written according to some guidelines provided by the vendor and may populate and return an object, e.g. a ‘CashFlow’ object, or an array of such object. The semantic content of the user-code describes the cash-flow(s) (the payoff) of an instrument for a generic Monte Carlo path. The particular way such payoff may be intended is also a function of some instrument definitions. For example, in the case of a simple ‘vanilla’ option, the user-code semantic is to compute the undiscounted payoff expressed in the numeraire currency. Market parameters, in particular all the relevant information concerning a Monte Carlo path, are available as properties of the date objects. Hence, in an embodiment, the user-code may comprise one or more expressions that comprise variables associated with a Monte Carlo path.

So, in the example of FIG. 4, the notation ‘Expiry.Spot’ exposes the spot value on a given Monte Carlo path of the underlying asset (in the case of single-asset instrument). Such value, which, in general, is different in each of the Monte Carlo paths, is then compared to the ‘Strike’, an object of type ‘Double’ defined in instrument definitions. The output ‘CashFlow’ object is finally loaded with the amount of the payoff, the denomination currency and a reference to the date in which such payoff is paid/received. The currency in which such payoff is expressed has been automatically pre-set by programmatic source-code in accordance to instrument definitions and user-inputs at pricing time. The payoff date reference, in the case of a simple ‘vanilla’ option, is the ‘Expiry’ (which contains information about the associated settlement date, discounting factors and changes of numeraire conversions), but there are no limitations; in general, the payoff date could be different from the date used to determine the payoff amount.

Hence, from the above it follows that the design module is configured to generate a programmatically generated source code for a user-defined instrument wherein the source code is a well-formed string (a sequence of semantic expressions following a certain syntax) that is generated by combining the code wrapper strings with the user-code string
Thereafter, the pricing system may compile the resulting combined source code on the fly using a compiler object and store the executable in a memory. In an embodiment, the executable may be stored in a library, e.g. a dll library.

### Building Validation Code

As mentioned above, in an embodiment, the pricing system may also be configured to set validation rules at design time. A validation rule may be written in a syntax of the programming language and may refer to variables that have been properly defined. In the case of a simple ‘vanilla’ option, the following validation rules could be defined, for example:

| | |
|---|---|
| Strike > 0 | (enforced in all contexts) |
| Expiry > EvalDate | (enforced only in a ‘pricing at inception’ context) |

The semantic of a validation rule is a logical condition. When the condition, valued at pricing time is ‘true’, validation is successful; when the condition is ‘false’, the user-interface may prevent pricing the instrument and report to the user an error message. An error message is indeed associated to each validation rule at editing time. Furthermore, a validation rule may be attached to a specific object variable. For example, the first rule may be attached to the ‘Strike’ variable and the second rule to the ‘Expiry’ variable; this allows the user interface, at pricing time, to report validation errors in the most relevant part of the graphical user interface.

The logical condition can be as complex as desired. Any rule can combine any of the variables defined in the instrument definitions. Furthermore, a special ‘Spot’ variable is also made available automatically, representing the spot reference value at pricing time. In case of multiple assets, an array of Spot variables is made available. Rules can combine conditions and variables by using logical operators and parentheses as permitted by the syntax of the programming language.

For example, for a ‘barrier’ option and in a ‘pricing at inception’ context, it may be required to price an option that is not currently triggered. May an object enumerator variable named ‘UpDown’ be defined to describe the direction of the barrier and an object ‘double’ variable named ‘Barrier’ be defined to represent the barrier level, a possible validation rule (in VB.net) would look like:

“(UpDown=Up AND Barrier>Spot) OR (UpDown=Down AND Barrier<Spot)”.

When the source code is built, the pricing system may programmatically write source code in the form of a subroutine that takes as an input the value of one or more variables at pricing time and outputs a list (that may be empty if all rules are validated) containing error messages and failed validation rules to be intercepted and reported to user by the application.

When validation rules would be themselves invalid (in the sense that their syntax cannot be translated into a logical condition, according to the rules of a programming language), the compiler would fail and it would not be possible to build the code and therefore price the instrument.

In one embodiment of the invention, different set of rules may be applied to different contexts. In particular, the ‘pricing at inception’ context may contain more stringent validation rules, as compared to other contexts, such as ‘simulation’ or ‘revaluation’. In such embodiment, different validation codes must be programmatically created and launched as a function of the context.

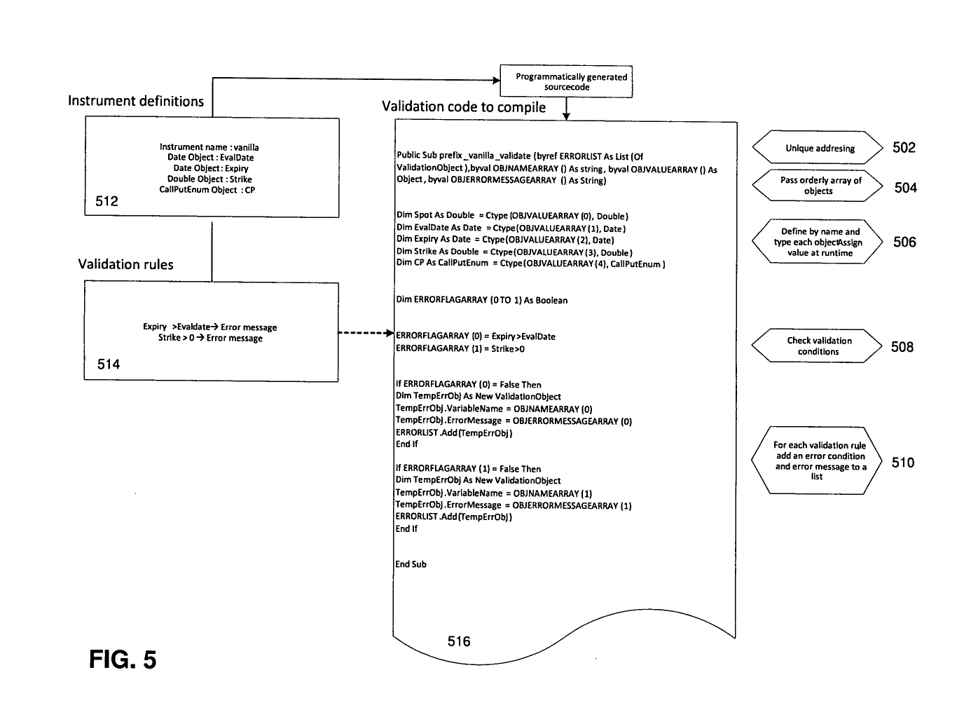

FIG. 5 depicts a schematic of string manipulation for generating a programmatically generated source code for the purposes of input validation according to an embodiment of the invention. In particular, FIG. 5 the valuation of a programmatically generated source code for a simple ‘vanilla’ option (as already described with reference to FIG. 4) using validation rules 514, in particular the two aforementioned validation rules. The thus generated source code may be referred to as programmatically-generated source code for validating a financial instrument or in short the validation source code 516. The validation source code may comprise various expressions that are discussed hereunder in more detail.

### Unique Addressing

Just as for the programmatically-generated source-code for pricing the user-defined instrument in FIG. 4, also the validation source code may be uniquely addressed (step 502) by embedding in the name of the subroutine the unique instrument name ‘vanilla’.

### Passing Orderly Instrument Objects Values to User-Code

Just as for the main pricing source-code, the subroutine must pass at pricing time the orderly value of one or more objects (step 504) (such as the ‘strike’); therefore, the pricing system builds the source code such that the relevant variables are defined correctly (as far as their name and type is concerned) and initialize them by taking the correct value at runtime (step 506). In an embodiment, variables that are not part of instrument definitions, e.g. ‘Spot’ are also included in the process, in order to validate conditions that depend on the spot reference at pricing time. For example, a barrier option may contain validation rules (at least in a ‘pricing at inception’ context) whereby the barrier level may have a certain value relative to the spot reference.

### Valuing Validation Conditions

For each validation rule, the pricing system may programmatically create source-code, in the form of a (well-formed) string. On the basis of the rules and syntax of the programming language, a source code may be generated that is configured to value Boolean conditions (step 508). When a validation rule is written properly, the compiler of such language may interpret a logical condition as Boolean, Because variables are properly populated at pricing time with actual values, the source-code may effectively intercept non-complying situations and report errors.

### Returning a List of Non-Fulfilled Rules and Error Messages

For each validation rule, the pricing system may programmatically generate a piece code for the validation source code that allows to populate a list of failed validation rules and attach such rules to a variable object and an error message, according to instrument definitions (step 510). That will allow the user interface, at pricing time, to interrupt pricing in case of a validation issue and report one or more validation errors, possibly referring to a specific input field, in turn associated to a variable object.

### Classes Representing Variable Objects

In the main embodiment of the invention, some special classes may be created by the vendor for the specific purposes of the invention. These classes may be visible by user-code and may expose properties and methods as applicable. All software objects that are required by the embodiments of the invention may reside in one or more specific modules, which is separate from the main module used in the application for editing and pricing an instrument. Every modern programming language establishes ‘visibility’ rules, by which software objects defined in various parts of a solution may or may not be visible by code written in a different part of a solution. All objects defined in a separate module may be visible by both the main application and the compiled user code. However, as far as properties of each object are concerned, only a subset may be visible to user-code and anyway such visible properties may be deemed as ‘read-only’ for user-code. As far as methods exposed by classes are concerned, depending on the purposes of the vendor, some may be visible to user-code and some may not be visible to user-code. In some cases, a different variant of the same method may be created by the vendor with different visibility levels.

The reason for different visibility and accessibility has to do with the prudential principle (need-to-know basis) according to which user-code may only be capable to access the properties and methods strictly necessary to implement a payoff description; while, in contrast, the main part of the application requires read and write access to many more properties and methods for the very purposes of the invention.

The reason for limiting user-code to have a read-only access to object properties is the fact that such objects are passed ‘by reference’ to user-code. Without a restriction, user-code may inadvertently modify a parameter, during the execution of a Monte Carlo path, which may instead remain fixed across all Monte Carlo paths. To avoid such risk and enforce consistency, it is always the main application code (at pricing time) loading and populating properties into objects, which remain therefore visible as read-only from the point of view of the user-code.

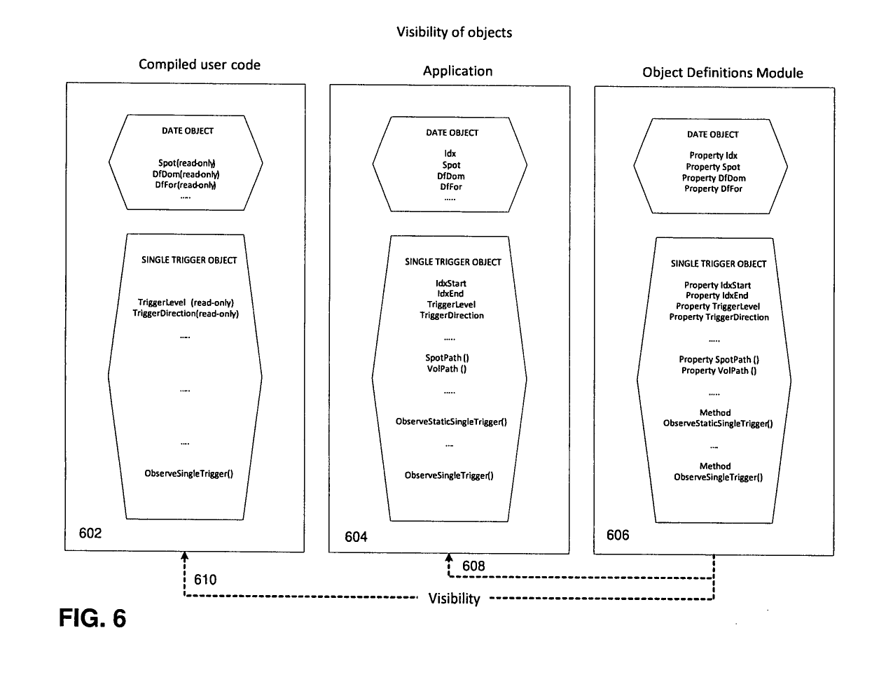

FIG. 6 depicts an example of the general scheme of visibility of classes according to an embodiment. In particular, FIG. 6 depicts a scheme of visibility of classes such as the date object and the single trigger object. In this example, all the properties of the date object can be read and written by the main part of the application. However, user-code can only read a subset of those properties. In this example, the single trigger object implements two methods, both visible by the main application. Only the second method, however, is also visible by user-code.

### The Date Object

The date object is the most important object in the embodiment of the invention and is particularly designed to carry all market information that is associated with a date. In particular the date object must implement properties in order to host:
The observation date (market or trading date)
The associated settlement date according to market conventions
Optionally a weight (used when an array of dates is part of a fixing schedule)
On a per-Monte Carlo path basis:
The price of every relevant asset
Optionally the volatility of every relevant asset
Optionally jumps information of every relevant asset
Interest rates of every relevant currency
Discount factors of every relevant currency
Change-of-numeraire information of every relevant currency

In one embodiment of the invention, the ‘asset’ price, on a per-path basis, may take the form of an array containing an entire forward yield curve, defined in terms of dates and yields.

All information is loaded by the main application code at pricing time, based on a Monte Carlo simulation and all relevant information is passed and made available to the compiled user-code. Subsequently, the results of user-code in terms of undiscounted payoffs are handled back to the main application code, which, on the basis of discounting and numeraire information held in a date object returned as part of the ‘CashFlow’ object, is capable of performing the appropriate discounting and aggregations and finally compute the instrument price.

### The Fixing Schedule Object

The fixing schedule object is constructed by implementing an array of date objects, each carrying information regarding such date. The weight property of date objects can be used to associate a fixing weight to each date of a fixing schedule. A fixed fixing is implemented by loading such fixing as asset price into the corresponding date object. In this way, user-code may abstract from whether a fixing date has been already fixed or not, therefore simplifying considerably the user-code.

The fixing schedule object exposes methods, for convenience, computing various aggregations of fixings, such as minimum, maximum, arithmetic average, geometric average, etc.

### Regular Types and Pre-Defined Enumerators

The application can also handle regular objects, which are used as input parameters, according to instrument definitions. The ‘double’, ‘integer’ and ‘Boolean’ regular types are supported, together with a number of enumerators that are pre-defined, for convenience, implementing terminology that is common in financial instruments, such as

A special user-defined type of enumerator can be used when none of the pre-defined enumerators are suitable for a particular product definition.

### Special Objects

The main embodiment of the invention implements a number of special objects (single and double triggers, extrema, holder choices, etc.) for the purpose of handling more accurately and more efficiently some features commonly found in financial instruments. In most cases, these objects are capable of performing the so-called continuity adjustments on Monte Carlo paths and return to user-code an appropriate probability factor. Taking a single trigger as an example, the observation of a trigger could be easily implemented by defining a schedule object with daily frequency and programming user-code to observe on each date whether the trigger condition has been fulfilled or not. However, this methodology is both computationally inefficient and theoretically incorrect, at least for instruments that are based on a continuous observation of a trigger.

A single trigger object is capable of computing on a per-path-basis a continuity adjustment and load into appropriate properties such adjustments. User-code may then ‘observe’ a barrier by simply adjusting the payoff by such factors. In order to compute such adjustments, many types of market data may be loaded in the trigger object by the main application at pricing time and on a per-path basis.

A single trigger object may be defined as ‘static’ when all its details are known before pricing, or as ‘dynamic’ when some details (such as the trigger level) may vary on a per-path basis. In other words, a ‘static’ trigger object is suitable when the trigger is unconditionally defined, while a ‘dynamic’ trigger is suitable when the trigger existence or characteristics are conditionally defined in user-code.

A static trigger object is automatically ‘observed’ by the main application code and its results are readily available to user-code.

A dynamic trigger is configured and populated by the main application code but not observed ex-ante, as its details are conditional. It is the duty of user-code, according to the documentation provided by the vendor, to populate the required details on a per-path basis and invoke the observation methods visible to user-code, which will compute the continuity adjustment and populate the continuity adjustment properties; finally, to use, as applicable, the continuity adjustment properties in user-code.

Both a static and dynamic trigger may optionally compute the expected ‘first trigger date’, conditional to a positive trigger condition. Such date object may be used by user-code for example in the context of pricing instruments such as the ‘instantaneous one-touch’ option.

The double trigger object is similar to the single trigger object and comes into two flavours: regular double trigger and sequential double trigger.

The extremum object applies continuity adjustments to determine the minimum or maximum asset price in a predefined period of observation.

The holder choices object implements methodologies used automatically by the main application code to handle user choices that depend on the estimation—for each path and at choice time—of the complete future probability distribution of states of the world.

### Building the User Interface at Pricing Time

Upon successful build of the programmatically created source-code (pricing code and validation code), the application may build a flexible user-interface, according to the definitions of the instrument. The user interface can be built by any graphical object that can flexibly handle a grid of user inputs, by using rows to manage each input variable and columns to manage fields associated with each row's input variable. The fields visible on each row may depend on the type of variable handled in such row in combination with instrument definitions.

### Initialization and Default Values

Initialization may be performed every time the pricing interface is requested to change instrument and partially when the pricing interface intercepts a change in the asset(s). The general initialization may at least:
Create rows to host each of the required variable objects, according to definitions
Create columns on each row, depending on the type of variable object hosted in said row
Manage the visibility of a row according to instrument definitions
Manage the accessibility of cells (edit/toggle/read-only) based on instrument definitions
Populate rows to host notional(s) according to instrument definitions
The specific initialization upon a change of asset(s), may involve at least:
Defaulting some values, according to definitions
Remapping some enumerators
Clearing fields
Forbidding payoffs in a non-deliverable currency

As far as remapping enumerators is concerned, for example a ‘PayoffCcy’ field may be accessible to user, in the context of a single-asset forex instrument, in order to specify whether the payoff currency may be DOM or FOR. Whenever the asset is changed (for example USD/JPY), the user interface, may allow the user to toggle the field between USD and JPY, while remapping such inputs into a DOM/FOR enumerator to be passed to user-code.

### Dates and Tenors

The user interface may allow users to enter dates in terms of tenors, by using short-codes such as ‘3M’ standing for ‘3 months’. For each row representing a date, the graphical interface will therefore show two items, the date and the tenor. If user enters a tenor, the corresponding date is computed and displayed, according to the calendars and conventions of the selected asset(s).

In a ‘pricing at inception’ context, the user interface may not allow user to enter dates that fall before the ‘evaluation date’ or ‘as of’ date.

### Fixing Schedules

The graphical interface may compute automatically the fixing dates of a schedule, as soon as all the information concerning such schedule has been populated, namely the start and end dates and the frequency. All schedule details (dates, weights, past fixings if available) must be held in memory and conveniently shown to user upon the action of ‘opening a schedule’. This can be accomplished, for example, by displaying a dialog form, when user ‘double-clicks’ the schedule row. The dialog form, may allow user not only to see the individual fixing dates, weights and past fixings, but also to edit such data. On any change, such data may be returned back to the graphical interface and stored in memory for further processing. The graphical interface may also show some synthetic information for a schedule, such as the total number of fixings.

### Booleans and Enumerators

All fields represented by enumerators may be pre-populated with a default value and user may be allowed to toggle (but not edit) such fields. The graphical interface may be aware of the items of every enumerator for correct handling and mapping of the displayed enumerator into an inner enumerator object.

### Numerical Fields

Numerical fields may be edited by user, depending on instrument definitions. Some basic validation is performed, raising errors when the text cannot be parsed as a number. Numbers may be re-formatted after entry following instrument definitions, for example as far as the number of decimals is concerned. For ‘integer’ types, the graphical interface may verify that a number does not contain decimals.

### Notional Amount(s)

The graphical interface may also display a notional field. This field may be expressed in a currency that depends both on instrument definitions and possibly by user inputs. In some cases, such as when pricing a single-asset forex instrument, there may be two nationals displayed. This may happen depending on the ‘pricing mode’ as part of definitions, when an instrument represents the simultaneous exchange of payoffs in different currencies at a predefined exchange rate. For example, a simple ‘vanilla’ FX option can be defined both in terms of DOM notional and in terms of FOR notional, the respective amounts being related by the strike price of the option, When an FX instrument ‘pricing mode’ is defined as ‘Delivery’ or as ‘OnExchangedNotionals’, the instrument definitions do require a reference to a ‘double’ variable hosting the relationship of such nationals, typically the ‘strike’. Therefore, with such information, the graphical interface may always consider one of the two displayed notionals as ‘leading’ and re-compute dynamically the other notional based on the first notional and the current value of the strike field.

In other pricing modes, only one notional amount field may be relevant and therefore displayed. Such field can automatically be toggled as a reaction to a possible change of the ‘PayoffCcy’ field that is always displayed in such pricing modes. For example, when pricing in ‘OnPayoff’ mode, the notional amount displayed is expressed in the same currency as the Payoff currency.

For multi-assets FX instruments, the notional is always expressed in the pre-defined payoff currency that cannot be toggled at pricing time.

For instruments of other asset classes, the notional is expressed in terms of the currency of denomination of said asset.

### Dynamic Validation

Every time the user interacts with the graphical interface, a dynamic re-validation of user inputs may be performed. A basic validation makes sure that every field is populated (not empty) and that input values can be parsed into the requested type, according to instrument definitions.

Only notional field(s) may or may not be populated. Depending on the population of such field(s) the system may provide as outputs instrument prices only or additionally also instrument premia or present values.

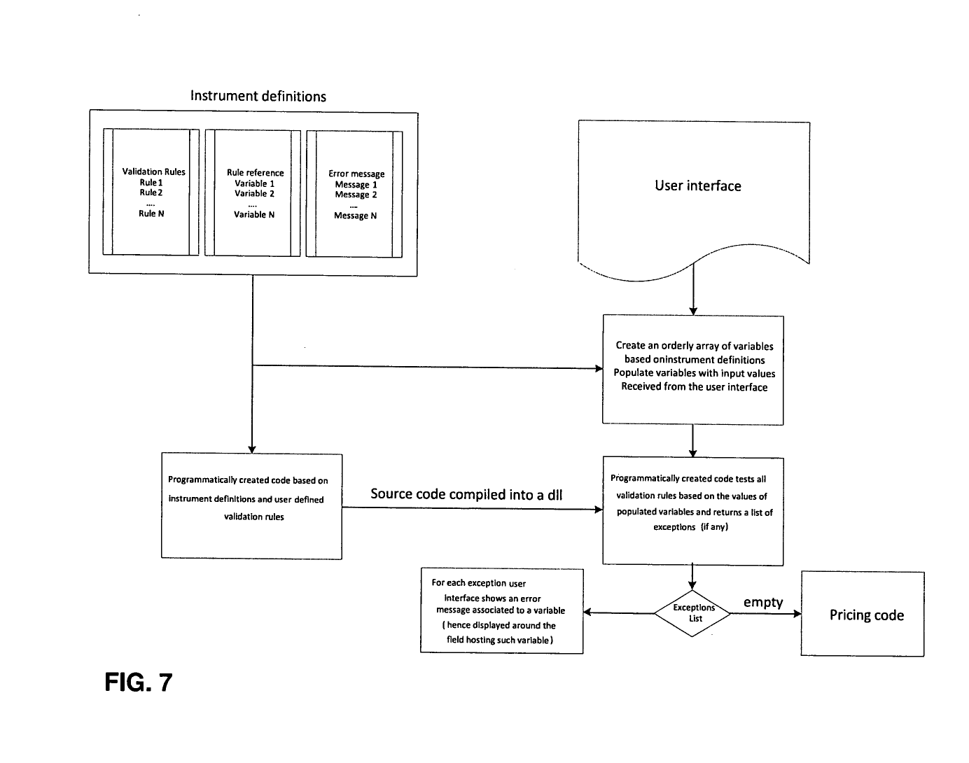

If the basic definition is fulfilled, a further advanced validation may be performed. FIG. 7 depicts such validation by invoking the compiled user-code and the validation subroutine.

By taking information concerning the instrument definitions and in particular an orderly list of variables and their types, the association of each validation rule to a specific variable and the association of an error message to every validation rule, the application creates arrays of data to be passed to the validation code. Such arrays are then populated using the current values of each variable, in turned parsed from the fields handled by the graphical user interface. In the process, a number of remapping processes may take place. For instance, a field describing the payoff currency in an FX single-asset context may take values such as EUR or USD in the user interface, depending on the underlying currency pair selected by the user; but such strings have to be remapped into strongly defined inner enumerators such as FOR/DOM for the purposes of validation.

The validation source-code automatically generated at build time on the basis of instrument definitions has been built and is accessible (e.g. in the form of a dll) to the pricing system, in particular the pricing module. Proper procedures are implemented to invoke the validation procedure and pass the aforementioned parameters in an orderly fashion.

The compiled validation code is then executed within a context that makes sure any exception can be captured by the main application. In case a validation rule is not fulfilled, an error message is displayed to user and the process is terminated. The compiled validation code may return a list (that may be empty) of unfulfilled validation rules, together with a reference to the main variable name to which such rule is attached and a user-defined error message.

If such list is empty, all validation rules were respected and the main application can proceed with pricing the instrument. Otherwise, for every element of the list, the user graphical interface may report an error message and attach such message to the field that hosts the variable related to said failed validation rule. The process then terminates and the instrument cannot be priced.

### Building Monte Carlo Paths at Pricing Time

In order to price an instrument, the pricing module needs to retrieve or build Monte Carlo paths based on current market data. In an embodiment, current market data may be hosted in a database. In that case, a calibration process may be initiated in order to find the optimal model parameters to minimize a measure of error between the calibrated paths and a number of inputs (typically the price or implied volatility of a number of known ‘vanilla’ options).

In one embodiment of the invention, a Monte Carlo engine calibrates and computes paths. The data associated with these computed paths may be used as input for the executable (the compiled programmatically-generated source code of the user-defined instrument). In another embodiment of the invention, a Monte Carlo engine calibrates the model and passes to the pricing code only the model parameters. Actual paths may be created directly in the pricing code.

The calibration process and Monte Carlo paths generation may happen on different hardware machines connected via a network interface or be performed on the same machine.

In the case of instruments depending on a multitude of assets, a Monte Carlo engine exists, capable of creating paths for each asset, while taking into account the possible cross-correlations among every asset return.

The market data and Monte Carlo processes to be performed are a function of the instrument definitions and the user inputs concerning the choice of asset(s) in the graphical interface.

The longest period available in a Monte Carlo simulation may be pre-fixed or adapted to the longest required tenor required by the instrument to be priced, provided there exists enough market data available on the market to calibrate the model to such tenor.

In general, for reasons related to the efficiency and performance of the calibration process, it can be assumed that a calibration engine may return paths and calibrated model parameters for a given discrete time-step, which in general may be larger than a daily step. Furthermore, such time-step may be increasing over time, so that short-end calibration results are denser in time-dimension than long-end results.

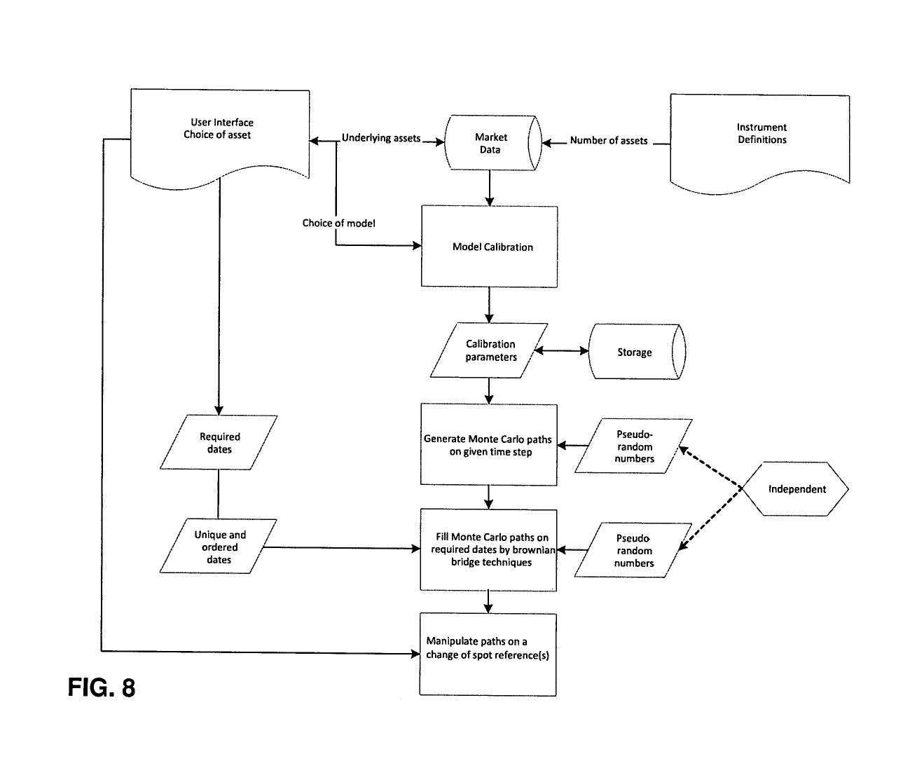

FIG. 8 depicts the preparation and manipulation of Monte Carlo paths based on a selected financial model, instrument definitions and other user inputs according to an embodiment of the invention. Instrument definitions may be applied in some cases to enforce or restrict the number and types of underlying assets. For example, in the case of an FX option based on an XXX/YYY currency pair and quantoed in a third currency ZZZ, the instrument definitions would force the choice of assets to the XXX/YYY and YYY/ZZZ pairs automatically. For example, in the case of a ‘basket’ option of a number of currencies vs. USD, the application would automatically determine all the USD/XXX currency pairs required for the definition of such basket. Therefore the choices of which assets are required to price an instrument are determined by crossing the instrument definitions and the user inputs in the graphical interface.

A user may also choose a specific pricing model (for example Heston, SLV, Sabr, etc.) to be used for pricing the instrument. In all cases, it is assumed that a calibration engine and Monte Carlo engine exist that are suitable for modelling paths according to said model.

For all the models, except for the theoretical ‘flat Black-Sholes’, a calibration process may be performed in order to determine the best model parameters in order to match market data. The relevant market data is therefore retrieved from a database and used to perform the calibration process. This process may involve a number of iterations and numerical procedures.

In general the required market data for each asset are spot prices, interest rates curves, volatility surfaces or cubes, correlations, etc. Most of such data can be represented in the form of term structures, in that parameters are applicable to a particular tenor or date. If any market data is not available up to and including the longest date required for pricing the instrument (as determined by user inputs in the graphical interface), then such instrument cannot be priced. Provisions may be implemented to overcome this limitation, either by allowing user to enter an estimation of the missing market data, or by using a number of techniques known in the art to provide an automatic estimation of such data, such as extrapolations, copulas, etc.

When the calibration procedure would yield reasonably accurate results, the estimated model parameters can be used to build Monte Carlo paths, for each underlying asset. The output of the Monte Carlo simulation may implement matrixes hosting all relevant information on the selected model. For example, in a complex model, the Monte Carlo engine may return for each path and time bucket the current zero-coupon interest rates (continuously compounded), the evolution of the spot prices, the evolution of stochastic and local volatility, the presence of a ‘jump’, etc.

Since the calibration of a financial model on given market parameters is an extremely costly operation from a computational point of view, the results of a successful calibration may be stored temporarily to a database (with a unique identifier), for further retrieval.

In general, the Monte Carlo paths computed so far would be available only for the time-buckets used during the calibration process and may not necessarily match all the dates that are relevant to price the instrument.

Based on instrument definitions and user-inputs in the graphical interface, all relevant dates are sorted so that an orderly array of unique required dates is made available.

By comparing the available dates in the Monte Carlo simulation and the required dates, the application can determine whether there are ‘gaps’ and where they are located in time-dimension. In this case, the application will use techniques that are known in the art (such as ‘Brownian bridges’) in order to fill the gaps and obtain a derived and denser Monte Carlo simulation that contains at the very least all the time-buckets required.

In an embodiment, a technique for filling the time gaps may be based on a pseudo-random number generator that is independent (in a statistical sense) from the generator used during the previous processes of calibrating and generating an initial Monte Carlo simulation. The gap-filling procedure may apply to all asset processes, as required by instrument definitions and to all relevant variables (such as spot evolution, volatility evolution, etc.) as required by the selected pricing model.

Finally, the application may incorporate code to manipulate Monte Carlo paths, for a subsequent change of the spot reference (while maintaining all other market data unchanged). In most cases and assuming the hypotheses known in the art as ‘sticky delta’ paradigm, a change of spot reference does not require a re-calibration of the model, but only an appropriate ‘shift’ of the value of Monte Carlo paths. In other circumstances, for example when the volatility parameters of an asset would change significantly for a change of the spot reference, this provision is not applicable and the application may initiate a full process of re-calibration of model parameters.

The end result of the code implementing Monte Carlo generation is that the application makes available proper Monte Carlo paths, calibrated on market parameters and appropriate for the required financial model, containing all relevant information at the very least on all dates that are relevant for the pricing of the instrument.

When it is necessary to output also some sensitivities of the instrument to a change of market parameters (the so-called greeks), a number of secondary simulations may be build and stored in memory, each performed with a slightly different value of one of the model input parameters.

### Pricing a User-Defined Instrument

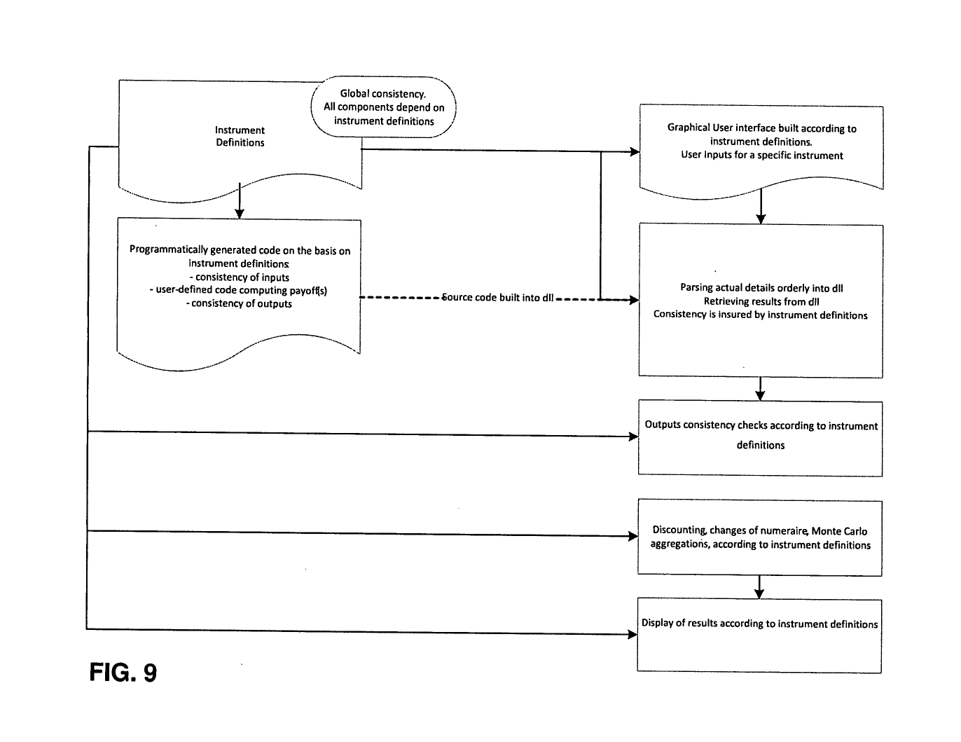

Before focusing on the pricing of a user-defined instrument—the final purpose of the invention—it is important to point out that all the components of the application and all the embodiments of the invention are globally consistent. Indeed, by accessing information available from the instrument definition, all components react consistently, as represented in FIG. 9.

All the displayed software components are designed to process information on the basis of instrument definitions, in particular:
The graphical user interface is created and behaves according to instrument definitions
The user interface executes validation rules, according to definitions
The programmatically-modified source code embedding user-code is manipulated, according to instrument definitions, in order to allow for an orderly passage of variable's values at pricing time and an orderly output of return values
The application code invoking the compiled source-code passes variables values in the correct order and retrieves the expected output values, based on instrument definitions
Post processing of return values, such as consistency checks, discounting, changes of numeraire, aggregation of Monte Carlo path's values are performed in accordance with instrument definitions
Output results are displayed to user in different formats and with different post-processing calculations, depending on instrument definitions

The process of pricing a user-defined instrument on a selected model, after the Monte Carlo paths for all relevant assets and dates has been performed, involves a number of steps:

### Populating the Date Objects

The data object may carry at pricing time, on a per-path basis, all the relevant information retrieved from the Monte Carlo simulation. So, the application executes a main loop, on a per path-basis, whereby for every date object that is necessary according to instrument definitions, at least the following information is computed and loaded in the object's properties: (an example for a single-asset FX instrument)
An internal index (not visible by user-code)
The date value
The settlement value corresponding to the date value, according to the rules, conventions and calendars, appropriate for the underlying asset
The asset price according to Monte Carlo simulation at that date
The FOR discount factor
The DOM discount factor
The change-of-numeraire factor
A weight

All the data are either readily available from information hosted by the Monte Carlo paths, or can be computed on the basis of such information.

In an embodiment of the invention, for instruments that depend on multiple assets, the settlement date would be computed based on joint rules and calendars; the date object would carry an ordered array of asset prices, one for each asset; there would be an array of FOR and DOM discount factors, one for each asset (the FOR discount factor can be interpreted as ‘dividend yield’ or ‘return of an asset’ or ‘holding cost’ etc., depending on the asset class), an array of change-of-numeraire factors would be computed and populated, one for each asset.

In an embodiment of the invention, when an entire term structure of interest rates may be considered as an ‘asset’, the asset price may be substituted by arrays hosting the time and yield of said interest rates curve.

In an embodiment of the invention, the weight property is used in the context of date objects that are associated to fixing schedules, while set to 1 and ignored for regular date objects.

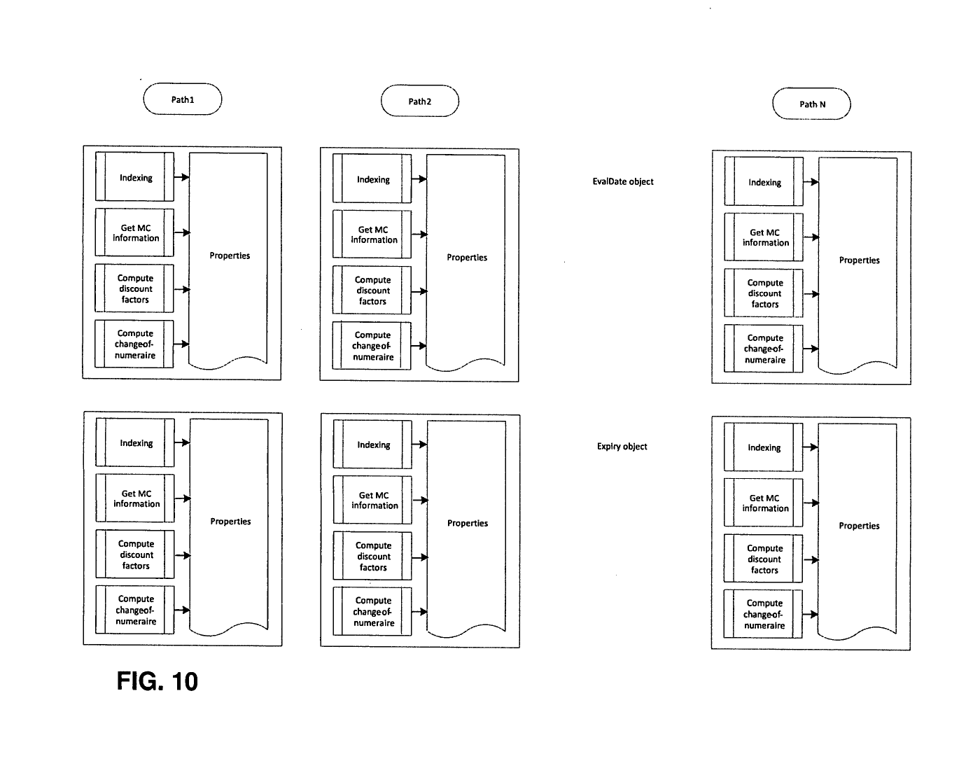

FIG. 10 depicts the population of date objects at pricing time on a per-MC-path basis according to an embodiment of the invention. In particular, FIG. 10 depicts a scheme of the loading of values in the date objects. In this particular example it may be assumed there are only two relevant dates in the instrument definitions, ‘EvalDate’ and ‘Expiry’.

As it may be clear from the example, an instance of each date object is initialized and populated on a per-path basis. For example, the ‘Spot’ property of the expiry object will host the asset price at expiry date for Monte Carlo path 1,2 . . . N at each iteration of the main Monte Carlo loop. In case of stochastic interest rates, the discount factors would also be path-specific, while in a model without stochastic interest rates, the discount factors would be the same on each path.

Thanks to an inherently consistent construction of the programmatically modified source code, the user-code may access the spot value of the asset at expiry by using the ‘Expiry’ object, which is visible by user-code and reading the (read-only) Spot property, with syntax like ‘Expiry.Spot’.

For the simple example of a ‘vanilla’ call option, a user-code syntax like ‘P=max(0,Expiry.Spot-Strike)’ would therefore compute in P the undiscounted value of a call option on each Monte Carlo path, since the Spot property contains the Monte Carlo asset value is each path, while the Strike variable is fixed along all paths.

### Populating the Fixing Schedule Objects

Since a fixing schedule object is an orderly container of date objects, its initialization and population is similar to the case of each date object. In addition, though, the main application code will also populate a weight, depending on user inputs and instrument definitions. In the case of ‘unweighted’ schedule, each weight is computed as an equal fraction of 1; in the case of ‘weighted’ schedule, each weight is computed as a fraction of the total input weights. Such weights are then loaded into the ‘weight’ property of each date object that is part of the schedule. Schedule objects expose some methods, for convenience, that may use such weights to compute for example arithmetic or geometric weighted averages of the asset values over time.

### Populating Objects for Other Types

The main application may also load various objects with the appropriate values. The population of such objects (for ‘double’, ‘integer’, ‘Boolean’ and enumerator types) is rather trivial. For example, the application may load into the ‘Strike’ object, defined as ‘double’ the value of the strike as defined by user input. Some mapping may be performed by the main application code, in the case of some enumerators.

### Populating Special Objects

Further provisions must be implemented for the correct handling of some special objects, such as single and double triggers, extrema, etc.

In the example of a single trigger object, the main application code may load into the object all information required to perform continuity adjustments, on a per-path basis. That includes a description of the trigger, such as the trigger level, the knock-in/knock-out trigger-type enumerator, the up/down trigger direction enumerator, etc. and market data in the form of the full asset-path over time, the full volatility-path over time, pre-computed time-differentials, etc. Since the trigger object contains also references to the start and end observation dates, that in turn contain an indexing over time, the methods can very effectively use such indexes to perform a proper computation of the continuity adjustments. Upon termination of such computations, some read-only properties are loaded into the object and are visible by user-code:
The applicable continuity adjustment (as a function of the knock-in/knock-out enumerator)
The no-touch probability (applicable to ‘knock-out’ types)
The touch probability (applicable to ‘knock-in’ types)

Conform to detailed documentation provided by the vendor, the observation of a trigger requires scaling the payoff by an applicable continuity adjustment factor. Indeed, for a given path, the trigger condition is not the traditional true/false dichotomy, but rather a full spectrum of probabilities ranging from zero to one. So, the payoff of a barrier option, for example, may be computed in user-code by the simple syntax: ‘P=max(0, Expiry.Spot-Strike)* Trigger.ContAdj’

In one embodiment of the invention, methods are provided, for convenience, in order to ‘attach’ parts of different triggers over time and return a correct continuity adjustment, based on the individual continuity adjustments of the input triggers. in one embodiment of the invention, a trigger can be defined as ‘dynamic’. This is the case for a trigger that:
May or may not be observed in a path, conditionally to some circumstances
May have different characteristics on a per-path basis

When a trigger object is defined as dynamic, all the relevant information is loaded into the object on a per-path basis, but methods are not executed automatically ex-ante. It is the duty of user-code to properly fill in the relevant details on a per-path basis, call the methods (which are visible) to compute the continuity adjustment and retrieve the results from the properties.

Hidden flag properties under control of the main code but not accessible by the user-code make sure that:
If methods have not been called in a path, properties cannot be read in such path

A dynamic trigger may come useful, for example, in order to price a forward start barrier option, an option whereby the barrier level is decided at some time in the future and in relation to the then—prevailing spot price of the underlying asset.

Trigger objects also may optionally compute and populate a date object, representing the first trigger date provided the trigger was hit. Such date object may be used to reference the payoff date of an option, for example in the case of an ‘instant one-touch’ option.

The purpose of special objects is to provide a more accurate and more performing measure of some quite common features, under strictly controlled conditions.

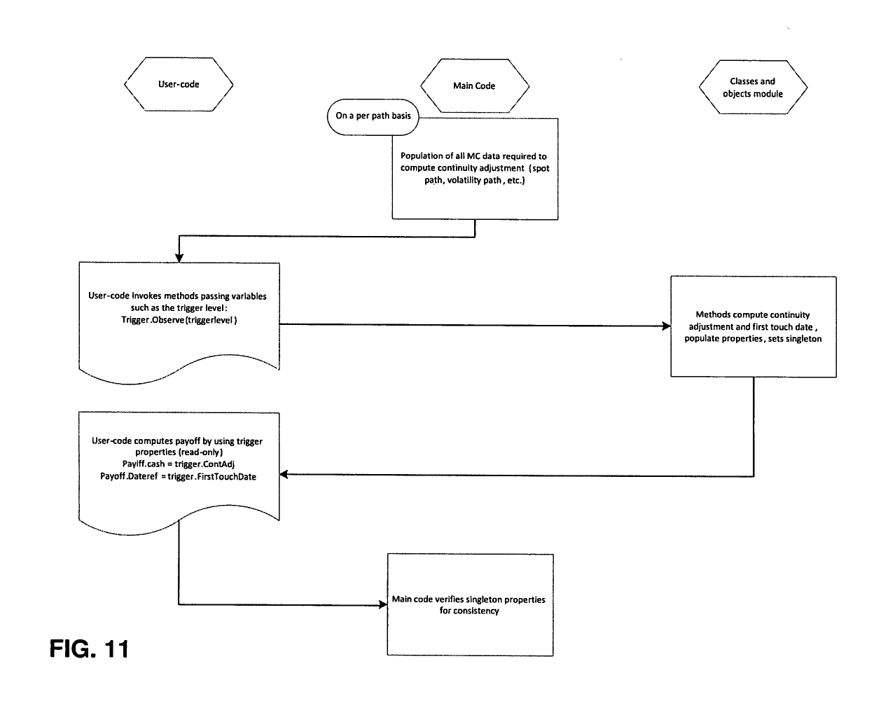

FIG. 11 depicts a general scheme for the handling of complex objects, such as trigger's continuity adjustments according to an embodiment of the invention. In particular, FIG. 11 depicts an example of the inner processes affecting a dynamic trigger with first touch date (to compute a forward-start, instantaneous-one-touch option).

In the case of dynamic trigger, details of such trigger can only be determined on a per-path basis conditionally to one or more events. The user code invokes the trigger methods and passes the relevant variables, in this case the trigger level, Methods are executed in the objects definitions module that has fully visibility of all relevant data and variables. Methods load output properties such as the continuity adjustment and the first touch date. The first touch date is itself a date object and will be loaded with all its own properties, such as the appropriate discount factors and change-of-numeraire values. This is made possible precisely by the fact that such module has full visibility on all variables. The method also sets control flags. The user code can now access the properties of the trigger and in particular is using the continuity adjustment property to compute the undiscounted payoff and the first touch date as a reference date indicating when such payoff may be paid. When user-code execution is terminated, the main code will access some hidden properties of the trigger and verify that its properties have not been accessed by user-code before invoking its methods, a strong control on well-formed well-behaved user-code.

### Executing User-Code

Because of the inner consistency relating different part of the inventions, the programmatically modified user-code may be compiled into a dynamically linkable file, e.g. dll file, which can be linked and invoked dynamically by the main application. Moreover, the inner consistency provides an orderly method for passing input parameters and variables to user-code.

It is submitted that all or at least some inputs are passed by ref to user-code, or, to put it differently, only a ‘pointer’ to the memory location hosting such data is passed to user-code, not a copy of the actual data. This ensures that copious amount of data can be accessed by the user-code without affecting performance. At the same time, the limitation imposed on object properties that are read-only in respect to user-code makes sure that user-code cannot modify input data, a potentially very dangerous circumstance, which may result is unpredictably wrong results.

The whole execution of user-code is embedded into an exception handler that guarantees to capture any exception in an orderly manner and report an error to the user.

A special type of exception is further created in the UserObjects module as a specially inherited type and made visible to user-code. In other words, user-code may programmatically throw such a special exception to interrupt the execution and report a message to user.

The programmatically modified user-code also manipulates the source code in order to force an output that is consistent with instrument definitions. Such output may be;
A single CashFlow object
An array of CashFlow objects
Each CashFlow object further contains the following properties:
A currency reference
A cash amount
A date reference

It is the duty of user-code to compute an undiscounted payoff in the form of a single or array of cash-flows, populate such outputs and return them to the main code, following detailed instructions provided by the vendor.

### Discounting Payoffs

After user-code returns control to the main application code, a number of checks are implemented in order to guarantee the consistency of pricing, according to instrument definitions. In particular the following checks are performed, for each cash-flow returned by user-code:
Return object is not empty
Return object is consistently a single object or an array of objects, depending on definitions
Return object is of the CashFlow type
Each CashFlow objects have been populated
Currency is consistent with instrument definitions (may vary depending on user-defined payoff currency in some types)
Cash has been populated
DateRef is a date object and has been populated

In some ‘pricing modes’, where the instrument payoff can be interpreted as an exchange of notional amounts expressed in different currencies (such as a simple ‘vanilla’ FX option), the instrument definitions also require to indicate a reference to a date variable, such as ‘Expiry’. This condition is checked by verifying that each date reference object that is part of the CashFlow object returned by user-code is indeed the required ‘Expiry’ date, in all Monte Carlo paths. The application therefore enforces strong consistency checks on the user-code outputs.

Additionally, when some special objects have been defined as part of instrument definitions, further checks may be performed, such as checks to verify that some properties have not been accessed by user-code before invoking the required methods.

On a per-path basis, the application will then discount each cash-flow (looping in the case of multiple cash-flows) using the appropriate discount factor (as loaded in the date object associated with such CashFlow object), depending on the currency in which such cash-flow is expressed. Furthermore, the discounting will also take into consideration a change-of-numeraire factor (also loaded in the date object associated to each CashFlow object), as a function of the payoff currency.

The result of the aggregation of all the discounted cash-flows will yield a Monte Carlo present value of the instrument of a per-path basis.

The result of the aggregation and averaging of all present values along all Monte Carlo paths will yield the price of the instrument, expressed in a notation that is consistent with instrument definitions.

In an embodiment of the invention, the main code may also use output information to estimate the so called Monte Carlo error or standard deviation, a measure of uncertainty of the price of an instrument when valued using the Monte Carlo methodology.

### Handling Choices

The main code may implement further steps in the presence of ‘choices’ that cannot be established on a per-path basis, but instead do require a knowledge of the entire distribution of future value of assets. In the presence of ‘choice’ objects, or in the specialized case of ‘American’ style or ‘Bermudan’ style options, the following steps may be further implemented:
The ordering of ‘choices’ over time according to the timing of such choices
The computation of final states of the Monte Carlo paths
The computation of an estimation of values of the instrument at different points in time
By using techniques very well known in the art
The backward computation of choices
The aggregation and discounting of values ‘provided choices were made’

### Displaying Results

After all the processes, a final present value of the instrument is available. Such value may be expressed in different currencies depending on instrument definitions. The graphical interface may then report results expressed in different currencies, notations and conventions, as a function of instrument definitions. For example, an FX vanilla option may be expressed both in FOR % or in DOM pips, while a digital FX option may be expressed only in FOR % or DOM % depending on the selected payoff currency. In some cases the main code will perform some final manipulation of prices. For example, a price can be expressed ‘in pips’ by multiplying it by a factor that depends on market conventions of an underlying currency pair.

Furthermore, the main code may switch the signs of prices, depending on the selected ‘point of view’ of the user (long/short, we buy/we sell) and represent such prices in terms of a notation ‘We pay/We receive’) in order to avoid ambiguity.

If a notional has been explicitly entered by the user, the main application code may further compute the premia/present value amounts, by multiplying the appropriate notional(s) with the appropriate price. The exact way to compute premia from prices depends on instrument definitions.

If sensitivities (the so-called ‘greeks’) need to be reported, then the system will compute them by difference, comparing the ‘main’ pricing result with ‘secondary’ pricing results, achieved by performing the same code but on one shifted market parameter. The pricing process can be fully parallelized, so that a number of simulations (a main one for the price and several secondary ones for the ‘greeks’) can be performed at the same time, provided there is enough hardware capability.

Greeks may also be displayed to user in different formats or following different conventions, depending on instrument definitions.

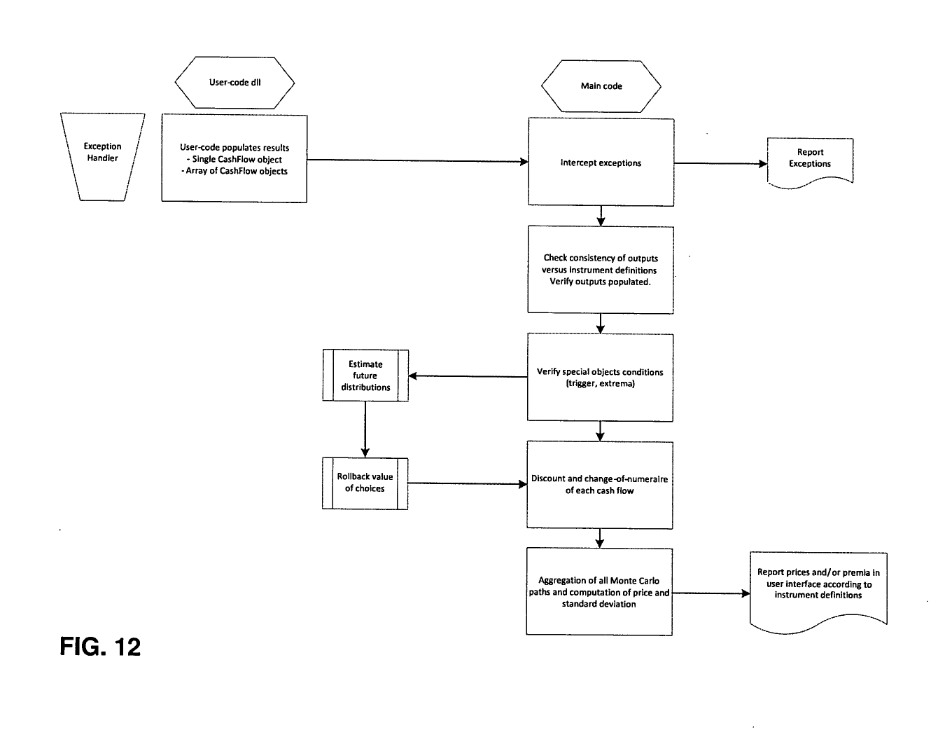

FIG. 12 depicts processes taking place after invoking user-defined code, such as discounting and aggregating Monte-Carlo paths results according to an embodiment of the invention.

### Pricing or Revaluing a User-Defined Instrument After Inception

While at inception all relevant dates are by definition falling after or at most on the EvalDate (that is always pre-defined by the application), this is not true for an instrument that has to be priced or re-valued ‘in progress’ or at any other time during its life-cycle.

The main embodiment of the invention allows a correct revaluation in all circumstances, by forcing the user interface to declare status variables that are then loaded into object properties and passed to user-code. In most cases, user-code may not implement special provisions to handle past dates and/or status variables.

### Handling Past Dates

For every relevant date whereas a date object has been created, as mentioned above, the main application loads all Monte Carlo variables into the object properties. In particular, in the simplified case of a single-asset instrument, the application loads the Spot property and discount factors properties in each date object on a per-path basis. In a more general context, there are three possibilities of relative position of a date and the EvalDate:
Date>EvalDate, the usual logic applies
Date<EvalDate, the user interface requires user to enter the Spot observed on such date and this observed Spot is loaded into each instance of the date object in every Monte Carlo path; similarly, discount factors are forced to 1, in all Monte Carlo paths;
Date=EvalDate, the user interface allows user to enter the Spot observed on such date or to leave it blank, therefore distinguishing the situation whereby such Spot has been ‘fixed’ for the purposes of the instrument, versus the situation whereby such Spot still has not been fixed.

This may be the case of a ‘vanilla’ option expiring on the EvalDate, before or after the expiry cut time. Depending on the user input, the system will treat the market data associated to said date according to the first or second case, as appropriate

It is worth noting that a user-code describing a ‘vanilla’ option payoff as ‘max(0, Expiry.Spot-Strike)’ would be automatically priced correctly even after expiry. Indeed, after expiry, all Monte Carlo paths will hold the ‘fixing spot at exercise’ and discount factors of 1, hence collapsing the code automatically into the value of a known cash-flow paid/received ‘today’.

### Handling Past Dates in Fixing Schedules

Similarly to single dates, a fixing schedule object will require the user, through the graphical interface, to enter an appropriate fixing for all dates in such schedule that are falling before or equal to the current EvalDate. And again, for a date equal to EvalDate, user can input a fixing indicating such fixing is already known or leaving it blank, indicating such fixing hasn't been fixed yet during the day.

By similar logic, all dates where a fixing is necessary will be populated with such fixing (equal for all Monte Carlo paths).

As before, it is worth noting that any instrument whose value may depend on a number of fixing in the fixing schedule will be handled correctly as it evolves over time, without the need for the user to write special provisions in user-code.

It is also worth noting, that the principle according to which a date object is loaded with fixings as opposed to Monte Carlo values can be applied for as many asset prices as required in the instrument definitions and the principle can therefore be extended to any number of assets.

### Handling the Past Status of Special Objects

For a number of objects, one or more status variables may be required to handle correctly instruments that are priced ‘in progress’ or at any time during their life-cycle. For example, in the case of single triggers, the user interface will expose a date field every time the EvalDate falls between the start and end observation dates of said trigger. User can indicate the triggered status of the barrier by entering the first trigger date.

In such case, the methods computing continuity adjustments will return fixed probabilities (zero for the probability of no-touch and one for the probability of touch) for all

Monte Carlo paths. Therefore, the continuity adjustments will correctly handle the case of a trigger already hit in the past, without any special provision in user code. Needless to say, the first touch date property would be set equal to the date provided by the user in the graphical interface. A similar methodology, but allowing for separate touch dates for lower and upper triggers, is applicable to double triggers objects.

For extrema, the user interface will require user to enter the current minimum or maximum (as applicable) observed ‘so far’, every time the EvalDate falls between the start and end date of the observation period of the extremum. By analogy with other objects, such current extremum value will be used appropriately by the object's methods.

And similarly again, for user choices that must have happened in the past, the user interface will force the user to declare which past choice was made and will use such information to populate objects and process methods.

As it becomes apparent, the invention does contain automatic provisions to perform the correct pricing of an instrument all along its ‘life-cycle’.

In one embodiment of the invention, in a revaluation or simulation context for example, the instrument details here including past fixings and past status variables are provided by a database. The processing logic is absolutely similar, except that there is a database providing information as opposed to a human user. All validation procedures remain in place in both cases; all processing is performed similarly in both cases.

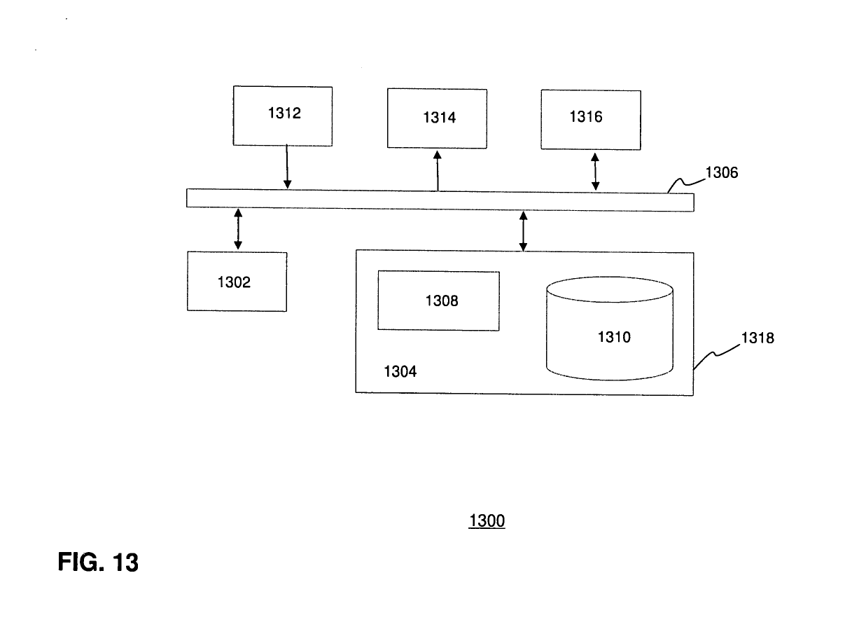

FIG. 13 is a block diagram illustrating an exemplary data processing system that may be used in this disclosure. Data processing system 1300 may include at least one processor 1302 coupled to memory elements 1304 through a system bus 1306. As such, the data processing system may store program code within memory elements 1304. Further, processor 1202 may execute the program code accessed from memory elements 1304 via system bus 1306. In one aspect, data processing system may be implemented as a computer that is suitable for storing and/or executing program code. It should be appreciated, however, that data processing system 1300 may be implemented in the form of any system including a processor and memory that is capable of performing the functions described within this specification.

Memory elements 1304 may include one or more physical memory devices such as, for example, local memory 1308 and one or more bulk storage devices 1310. Local memory may refer to random access memory or other non-persistent memory device(s) generally used during actual execution of the program code. A bulk storage device may be implemented as a hard drive or other persistent data storage device. The processing system 1300 may also include one or more cache memories (not shown) that provide temporary storage of at least some program code in order to reduce the number of times program code must be retrieved from bulk storage device 1310 during execution.

Input/output (I/O) devices depicted as input device 1312 and output device 1314 optionally can be coupled to the data processing system. Examples of input device may include, but are not limited to, for example, a keyboard, a pointing device such as a mouse, or the like. Examples of output device may include, but are not limited to, for example, a monitor or display, speakers, or the like. Input device and/or output device may be coupled to data processing system either directly or through intervening IO controllers. A network adapter 1316 may also be coupled to data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks. Modems, cable modems, and Ethernet cards are examples of different types of network adapter that may be used with data processing system.

As pictured in FIG. 13, memory elements 1304 may store an application 1318. It should be appreciated that data processing system 1300 may further execute an operating system (not shown) that can facilitate execution of the application. Application, being implemented in the form of executable program code, can be executed by data processing system 1300, e.g., by processor 1302. Responsive to executing application, data processing system may be configured to perform one or more operations to be described herein in further detail.

In one aspect, for example, data processing system 1300 may represent a client data processing system. In that case, application 1318 may represent a client application that, when executed, configures data processing system 1300 to perform the various functions described herein with reference to a “client”. Examples of a client can include, but are not limited to, a personal computer, a portable computer, a mobile phone, or the like.

In another aspect, data processing system may represent a server. For example, data processing system may represent an (HTTP) server in which case application 1318, when executed, may configure data processing system to perform (HTTP) server operations. In another aspect, data processing system may represent a module, unit or function as referred to in this specification.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer-implemented method for enabling pricing of a user-defined financial instrument, said method comprising a microprocessor in a computer executing computer readable program code of a main application, said program code being associated with an object-oriented programming language that comprises one or more compiler classes, said program code being configured for:
providing a first user interface for receiving instrument definitions and user-code defining the contingent cashflows of at least part of a user-defined financial instrument as a function of at least part of said instrument definitions;
receiving said user-code and at least part of said instrument definitions from a user interacting with said first user interface, said instrument definitions comprising at least an instrument name and one or more instrument objects and said user code comprising semantic expressions in accordance with the syntax of said object-oriented programming language;
using said instrument definitions and said user code for programmatically generating a code wrapper in accordance with the syntax of said programming language, said code wrapper comprising semantic expressions configured for orderly passing of at least part of said instrument objects to corresponding instrument parameters in said user code and orderly returning output objects representing contingent cashflows values;
combining said user code and said code wrapper into the source code of a pricing module; and,
compiling said source code into an executable pricing module by invoking said one or more compiler classes of said object-oriented language.

2. The method according to claim 1 wherein said instrument objects comprise one or more date objects that refer to one or more dates within a period that is relevant for the pricing of said user-defined financial instrument.

3. The method according to claim 1 wherein said code wrapper comprises a first well-formed string of expressions and said user-code comprises a second well-formed string of expressions and, wherein combining said user code and said code wrapper further comprises:
forming said derived source code by combining said first string with said second string of characters according to the syntax of said object-oriented programming language.

4. The method according to claim 1 wherein said code wrapper is further configured for defining the one or more variables in said user-code consistently with the instrument definitions; and/or, one or more output objects wherein said user-code is configured to populate said one or more output objects at runtime.

5. The method according to claim 1 wherein said user code further comprises one or more validation rules comprising a logical condition associated with at least one of said instrument variables in said user-code and wherein said one or more validation rules comprise semantic expressions that are in accordance with the syntax of said object-oriented programming language; said method comprising:
using said instrument definitions and said one or more validation rules for programmatically generating source code for a validation module, said validation module comprising semantic expressions configured for orderly passing of at least part of said instrument objects to corresponding instrument parameters in said validation subroutine; and,
for generating error conditions on the basis of one or more logical conditions in said one or more validation rules;
compiling said source code of said validation module, into an executable validation module by invoking said one or more compiler classes of said object-oriented language.

6. The method according to claim 1 further comprising:
linking said executable pricing module and, optionally said executable validation module, to the main application at runtime.

7. The method according to claim 1 further comprising:
selecting a pricing model for describing the evolution over time of the price of one or more assets and one or more other variables that are relevant for said pricing model, on the basis of stochastic processes, the value of said user-defined financial instrument being derived from said evolution over time of the prices of one or more assets and said one or more other variables that are relevant for said pricing model;
using said selected pricing model for generating one or more Monte Carlo paths on the basis of current market data of said one or more assets that are stored in a database, said one or more Monte Carlo paths comprising at least price and/or volatility information of said one or more assets as a function of time; and,
executing said executable pricing module, on the basis of at least part of said price and/or volatility information of at least one of said one or more Monte Carlo paths; and,
receiving from said executable pricing module at least part of the payoffs associated with said at least one Monte Carlo path.

8. The method according to claims 7 wherein executing said executable pricing module comprises:
loading at least part of said price and/or volatility information into one or more software-objects, wherein said one or more software-object are accessible at runtime by said executable pricing module.

9. The method according to claim 7 further comprising:
enforcing said one or more paths to conform to the requirements set by instrument definitions.

10. The method according to claim 7 further comprising:
processing said price and/or volatility information in said one or more Monte Carlo paths so that said price and/or volatility information is available for every point in time required by said instrument definitions and instrument parameters.

11. The method according to claim 6 further comprising:
determining the payoffs for said instrument by invoking said executable pricing module for one or more Monte Carlo paths;
determining the discounted payoffs by performing operations of discounting and, optionally, changes of numeraire, in accordance with instrument definitions for each of said payoffs;
determining the price and, optionally, the sensitivities of said user-defined financial instrument on the basis of said discounted payoffs by aggregating and/or averaging said discounted payoffs over one or more Monte Carlo paths;
reporting said value and, optionally, said sensitivities to a graphical interface or to a database in a format that is consistent with instrument definitions.

12. The method according to claim 1 further comprising:
generating a second user interface, in accordance with instrument definitions, said second user interface being configured for modifying said one or more instrument parameters according to at least part of said instrument definitions.

13. A system for enabling pricing of a user-defined financial instrument, said system comprising:
a computer readable storage medium having computer readable program code embodied therewith, and a microprocessor coupled to the computer readable storage medium, wherein responsive to executing the computer readable program code, the processor is configured for executing computer readable program code of a main application, said program code being associated with an object-oriented programming language that comprises one or more compiler classes, said program code being configured for:
providing a first user interface for receiving instrument definitions and user-code defining the contingent cashflows of at least part of a user-defined financial instrument as a function of at least part of said instrument definitions;
receiving said user-code and at least part of said instrument definitions from a user interacting with said first user interface, said instrument definitions comprising at least an instrument name and one or more instrument objects and said user code comprising semantic expressions in accordance with the syntax of said object-oriented programming language;
using said instrument definitions for programmatically generating a code wrapper in accordance with the syntax of said programming language, said code wrapper comprising semantic expressions configured for orderly passing of at least part of said instrument objects to corresponding instrument parameters in said user code and for and orderly returning meaningful output objects representing contingent cashflows values; combining said user code and said code wrapper into the source code of a pricing module; and,
compiling said source code into an executable pricing module by invoking said one or more compiler classes of said object-oriented language.

14. The system according to claim 13, wherein said program code is further configured for:
selecting a pricing model for describing the evolution over time of the price of one or more assets and one or more other variables that are relevant for said pricing model, on the basis of stochastic processes, the value of said user-defined financial instrument being derived from said evolution over time of the prices of one or more assets and said one or more other variables that are relevant for said pricing model;
using said selected pricing model for generating one or more Monte Carlo paths on the basis of current market data of said one or more assets that are stored in a database, said one or more Monte Carlo paths comprising at least price and/or volatility information of said one or more assets as a function of time; and,
executing said executable pricing module, on the basis of at least part of said price and/or volatility information of at least one of said one or more Monte Carlo paths; and, receiving from said executable pricing module at least part of the payoffs associated with said at least one Monte Carlo path.

15. The system according to claim 13, wherein said program code is further configured for:
loading at least part of said price and/or volatility information into one or more software-objects, wherein said one or more software-object are accessible at runtime by said executable pricing module.

16. The system according to claim 14, wherein said program code is further configured for:
determining the payoffs for said instrument by invoking said executable pricing module for one or more Monte Carlo paths;
determining the discounted payoffs by performing operations of discounting and, optionally, changes of numeraire, in accordance with instrument definitions for each of said payoffs;
determining the price and, optionally, the sensitivities of said user-defined financial instrument on the basis of said discounted payoffs by aggregating and/or averaging said discounted payoffs over one or more Monte Carlo paths;
reporting said value and, optionally, said sensitivities to a graphical interface or to a database in a format that is consistent with instrument definitions.

17. The computer program product comprising software code portions configured for, when run in the memory of a computer, executing the method steps according to claim 1.
